(19) United States
(12) Patent Application Publication
(10) Pub. No.: US 2002/0077930 A1
(43) Pub. Date: Jun. 20, 2002

(54) Contextual merchandising system for an electronic network

(76) Inventors: Philip G. Trubey, Rancho Santa Fe, CA (US); William Sutjiadi, San Diego, CA (US); Robert J. Millar, San Diego, CA (US); Mindy M. Bortness, San Diego, CA (US); Michael C. Herndon, San Diego, CA (US)

Correspondence Address: LAW OFFICES OF JAMES D MCFARLAND, 12555 HIGH BLUFF DRIVE, SUITE 280 A, SAN DIEGO, CA, 92130

(21) Appl. No.: 09/871,478

(22) Filed: May 31, 2001

Related U.S. Application Data
(60) Provisional application No. 60/208,297, filed on May 31, 2000.

(51) Int. Cl. G06F 17/60

(52) U.S. Cl. 705/26

(57) ABSTRACT

A networked system including a merchandising site for merchandising products to users who access the network via a browser. Content sites insert a request code in their web page so that when a user opens the page, a request is made for a palette from the merchandising site. A palette is served including products selected by the merchandising site that contextually relate to the web page and/or the content site. If the user selects a product, the user is connected with an on-line merchant, and a tag indicates a commission payable to the merchandising site. If a commission is paid to the merchandising site, then a portion is paid to the content site. The merchandising site provides tools to assist Buyers and Merchandisers, including smart tags used for purposes such as facilitating retrieval of product information and regularly updating the actionable products database.

### CROSS-REFERENCE TO RELATED APPLICATION

Priority is hereby claimed from U.S. Provisional Patent Application No. 60/208,297, filed May 31, 2000, entitled MERCHANDISING AND AFFILIATE REFERRAL SYSTEM FOR AN ELECTRONIC NETWORK.

### BACKGROUND OF THE INVENTION

1. Field of the Invention

This invention relates to electronic commerce. Specifically, this invention relates to information processing methods for merchandising and selling goods via the Internet or other on-line network.

2. Description of Related Art

Despite popular belief that “information wants to be free” even highly-frequented content Web sites are having trouble paying their bills, much less turning a profit. In an effort to stay in business, many websites have turned to advertising on their web pages; specifically, for a fee, banners or other ad are placed on the website of a content site. The content website can receive payment in a variety of forms, from a flat rate per month, to a fee based upon click-throughs. If the content website is a member of an affiliate program, then it may receive a commission directly from an advertiser.

However, the content website“s expertise is, in all likelihood, not advertising. Accordingly it is typically difficult for the content website to develop an effective advertising program on its own.

### SUMMARY OF THE INVENTION

A networked system is described including a merchandising site for merchandising a plurality of products to a plurality of users who access the network via a browser that views pages served by a plurality of content sites.

In one embodiment the system comprises a system usable by a Buyer in the merchandising site for selecting at least one product available from an on-line merchant and storing product information in an actionable products database, and a system usable by a Merchandiser to select actionable products for predetermined content sites that have reserved an area on their web pages. The content site inserts a request code in its web page so that when a user opens the page, the page generates a request for a palette from the merchandising site. Responsive to the request, a palette is displayed in the reserved area of the page, the palette including products selected by the merchandising site. If the user selects a product on the palette, the user is connected to a web site of a predetermined on-line merchant, together with an tag that indicates a commission is payable to the merchandising site. If a commission (such as a sales commission or a referral fee) is paid from the on-line merchant to the merchandising site, then a portion of this commission is paid from the merchandising site to the content site.

An example of a complete merchandising system is disclosed herein, including a Palette Serving Engine, a Business Integration Engine, a Reporting Engine, and a Merchandising Optimization Engine that includes a Buyer Console and a Merchandiser Console. Smart tags are created and used in one embodiment for purposes such as facilitating retrieval of product information.

### BRIEF DESCRIPTION OF THE DRAWINGS

For a more complete understanding of this invention, reference is now made to the following detailed description of the embodiments as illustrated in the accompanying drawing, wherein:

FIG. 1A, together with FIG. 1B, is a block diagram of one embodiment of a networked merchandising system;

FIG. 1B, together with FIG. 1A, is a block diagram of one embodiment of a networked merchandising system;

FIG. 2 shows an embodiment of a single product static palette with a vertical orientation, including a layout diagram on the left and an example on the right;

FIG. 3 is a layout diagram of a single product static palette with a horizontal orientation;

FIG. 4 shows an embodiment of a multi product dynamic palette with a vertical orientation, including a layout diagram on the left and an example on the right;

FIG. 5 is a layout diagram of product page, which is a type of multi-product static palette in which product information is displayed for multiple products at the same time;

FIG. 6 is a layout diagram of a gateway page that has hyperlinks to other product palettes, other product pages, or other gateway pages;

FIG. 7 is a flow chart of operations in one embodiment to select a palette and product list by the merchandising site in response to a request from a user browser;

FIG. 8, is a diagram illustrating the association between the page index in the products lists database, and the products in the actionable products database 118 in one embodiment;

FIG. 9 is flow chart of consumer transaction operations in one embodiment;

FIG. 10 is a high-level system block diagram of one embodiment of a merchandising site shown in FIG. 1A, showing interactions between four main engines;

FIG. 11 is a block diagram of one embodiment of a Palette Serving Engine (PSE);

FIG. 12 is a block diagram of one embodiment of a Reporting Engine (RE);

FIG. 13 is a flow chart of operations in one embodiment to synchronize the actionable products database with the product databases of the on-line merchants;

FIG. 14 is a block diagram of one embodiment of a Business Integration Engine (BIE);

FIG. 15 is a block diagram of one embodiment of a Merchandising Optimization Engine (MOE); and

FIG. 16 is a flow chart of operations to create a new product record in the actionable products database.

### DETAILED DESCRIPTION

This invention is described in the following description with reference to the Figures, in which like numbers represent the same or similar elements.

To facilitate a complete understanding of the invention, the description of the preferred embodiment is arranged within the following sections:

1. GLOSSARY OF TERMS AND ACRONYMS

2. OVERVIEW OF SYSTEM COMPONENTS AND OPERATION

3. PALETTES

4. CONSUMER TRANSACTION EXAMPLE

5. OVERVIEW OF COMPUTER PROGRAMS

6. PALETTE SERVING ENGINE

7. REPORTING ENGINE

8. BUSINESS INTEGRATION ENGINE

9. MERCHANDISING OPTIMIZATION ENGINE

1. Glossary of Terms and Acronyms

The following terms and acronyms are used throughout the detailed description:

Affiliate Program: (also known as associate, reseller or revenue sharing programs.) a marketing program in which merchants sign up webmasters (or affiliates) to resell their product through banner, text or product links posted on their website for a specified commission.

Client-Server. A model of interaction in a distributed system in which a program at one site sends a request to a program at another site and waits for a response. The requesting program is called the “client,” and the program that responds to the request is called the “server.” In the context of the World Wide Web (discussed below), the client is a “Web browser” (or simply “browser”) that runs on a computer of a user; the program which responds to browser requests by serving Web pages is commonly referred to as a “Web server.”

Commission. Any fee paid from a merchant site as a reward for procuring a buyer of the merchant's products (e.g. a sales commission), a potential buyer (e.g. a referral fee), or otherwise linking user with the merchant's site (e.g. a click-through fee).

Cookies. A technology that enables a Web server to retrieve information from a user's computer that reveals prior browsing activities of the user. The informational item stored on the user's computer (typically on the hard drive) is commonly referred to as a “cookie.” Many standard Web browsers support the use of cookies.

Extensible Markup Language (XML): A W3C specification for creating specific markup tags for specific data is a pared-down version of SGML. It allows designers to create their own customized tags, enabling the definition, transmission, validation, and interpretation of data between applications and between organizations.

Extensible Style Language (XSL): A W3C specification for separating style from content when creating HTML or XML pages. The specifications work much like templates, allowing designers to apply single style documents to multiple pages.

HTML (HyperText Markup Language). A standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document, and additionally in specifying how the Web browser is to display the document. HTML tags can be used to create links to other Web documents (commonly referred to as “hyperlinks”).

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions.

Hyperlink. A navigational link from one document to another, or from one portion (or component) of a document to another. Typically, a hyperlink is displayed as a highlighted word or phrase that can be selected by clicking on it using a mouse to jump to the associated document or documented portion.

Hypertext System. A computer-based informational system in which documents (and possibly other types of data entities) are linked together via hyperlinks to form a user-navigable “web.”

Internet A collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

ProductURL: A URL which specifies an on-line merchant's product specific web page for a given product.

ReferringURL: A ProductURL with the “referred by” attribute of the HTTP protocol set to the URL of the merchandising site when the user references that ProductURL.

Simple Object Access Protocol (SOAP): SOAP is a lightweight protocol for exchange of information in a decentralized, distributed environment. It is an XML based protocol that consists of three parts: an envelope that defines a framework for describing what is in a message and how to process it, a set of encoding rules for expressing instances of application-defined data types, and a convention for representing remote procedure calls and responses. HTTP bindings to SOAP facilitate remote procedure calls and responses across the Internet and Intranets.

URL (Uniform Resource Locator). A unique address which fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

Web Site. A computer system that serves informational content over a network using the standard protocols of the World Wide Web. On the Internet, a Web site typically corresponds to a particular Internet domain name, such as “cashpile.com,” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

World Wide Web (“Web”). Used herein to refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP, such as XML (eXtensibile Mark-up Language) and WAP (Wireless Access Protocol).

2. Overview of Ststem Components and Operation

A networked merchandising system is disclosed herein for use over an on-line electronic network such as the Internet. The system herein is described with reference to the Internet; however it should be apparent that the system can operate with any on-line network, such as a wide area network (WAN) or an intranet.

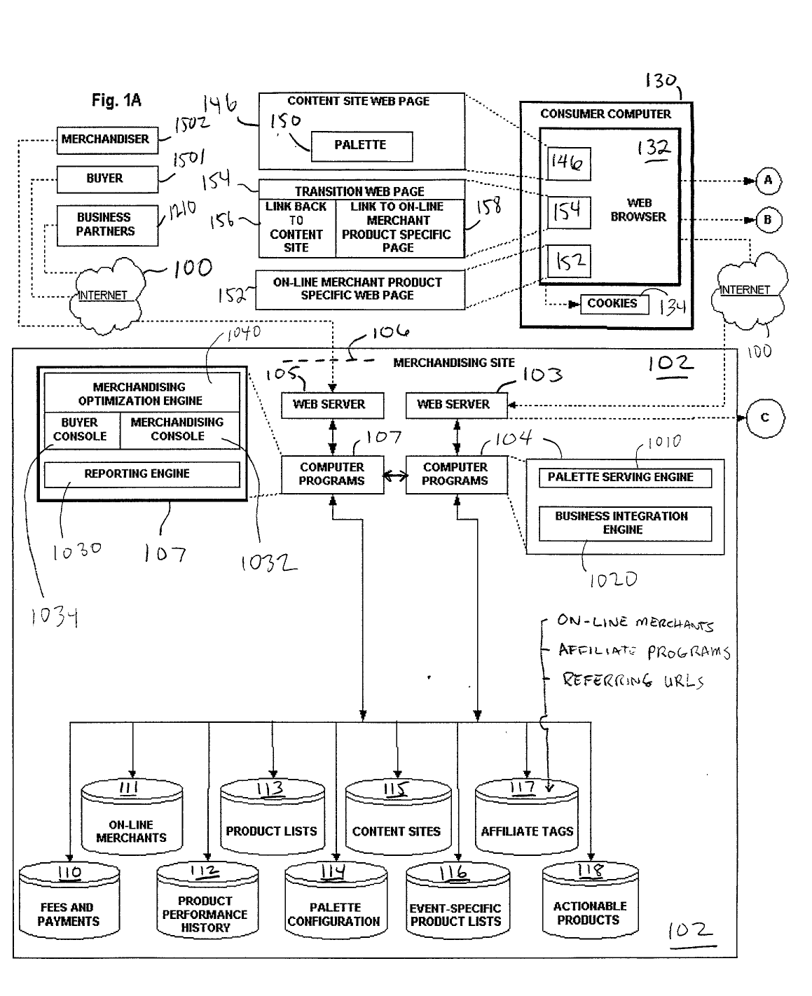

Reference is now made to FIGS. 1A and 1B which together form a block diagram of one embodiment of a networked merchandising system. An electronic network 100, referenced as the Internet in FIG. 1A and 1B, connects a merchandising site 102, a plurality of on-line merchant sites such as a first and second merchant site 121 and 122, additional merchant sites 123, a plurality of user browsers running on users' computers such as the consumer computer 130 that uses a web browser 132 to interface with the Internet, a plurality of content sites such as a first content site 140, and additional sites 141.

The merchandising site 102 will be first described briefly with respect to FIGS. 1A and 1B. The merchandising site 102 includes a web server that serves web pages using a plurality of computer programs and a plurality of databases connected thereto. Specifically in FIG. 1A, a first web server 103 serves pages to the Internet using a first group of computer programs 104, including a Palette Serving Engine and a Business Integration Engine. In addition, a second web server 105, which has restricted access as indicated by a dotted line 106, serves pages using a second group of computer programs 107 including a Merchandising Optimization Engine (MOE), and a Reporting Engine. The second web server is utilized to allow access to features such as product selection in the MOE and reporting features in the Reporting Engine by merchandisers, buyers, and/or business partners of the merchandising site as described elsewhere herein.

The first and second groups of programs 104 and 107 interact with each other as described elsewhere herein, in addition, the programs 104 and 107 utilize databases in the merchandising site including fees and payments 110, on-line merchants 111, product performance history 112, product lists 113, palette configuration 114, content sites 115, event-specific product lists 116, affiliate tags 117, and actionable products 118. As will be described in detail, the affiliate tags 117 designate the merchandising site as the payee to receive commissions from the on-line merchants; additionally, the affiliate tags uniquely identify the content site to the merchandising site, and accordingly a portion of any commission received by the merchandising site can be allocated to the identified content site and paid from the merchandising site to the content site.

In one embodiment the affiliate tags include three types, depending upon the on-line merchant and its affiliate or reward program. First, an on-line merchant that has its own affiliate program provides a plurality of tags to the merchandising site which then assigns one of the tags to each content site so that the merchandising site can identify the content site associated with any commission received. Second, an on-line merchant that is a member of a third-party affiliate program assigns a group of affiliate tags to the merchandising site, and then the merchandising site assigns a unique tag to each content site. For these first two cases (i.e. those merchants with their own affiliate programs or those who are a member of a third-party affiliate program, the product URL also includes the affiliate tag. Third, an on-line merchant that is not a member of a third-party affiliate program, or does not have its own program, is assigned a set of affiliate tags by the merchandising site; specifically, a plurality of referring URL tags are used to refer back to the merchandising site, and in addition, each of the referring URL tags uniquely identifies a content site. When any of these affiliate tags are associated with a commissionable event (e.g. a sale or referral), the commission is paid to the merchandising site. The merchandising site uses each of the affiliate tags in an on-line merchant's group to uniquely identify each content site, so that any commission attributable to a particular tag is uniquely associated with one content site. Using this information, a portion of the commission payable to the merchandising site is paid to the associated content site by any suitable system, such as electronic transfers on a regular basis. The portion of the commission payable to the content site is determined by the particular business arrangement between the merchandising site and the particular content site; for example a certain percentage of the commissions attributable to the content site may be paid, a fixed fee per sale, and so forth.

The on-line merchant Web sites 121, 122, and 123 are connected to the Internet to provide product information and various functionalities that allow customers to purchase products. Typically, the merchant site will be operated by a business entity (referred to herein as the “merchant”) that handles the various order processing, shipping, collections, and customer service tasks associated with the sale of goods. One example of an on-line merchant website is AMAZON.COM. The first on-line merchant site 121, which is representative of merchant websites that have in-house affiliate reward programs, include a web server 124 that serves web pages subject to the control of computer programs 125 that provide functions including shopping services that utilize a product database 126, and affiliate reward programs that utilize an affiliates/rewards database 127. One example of an affiliate reward program is disclosed in U.S. Pat. No. 6,029,141 to Bezos, et al., entitled “Internet-Based Customer Referral System”, which is incorporated by reference herein. The shopping services allow a browser connected to the web server 124 to request, retrieve and view product information such as description, price, and so forth stored in the product database 126. The control programs 125 may include a web server log analysis programs that allow the site to track transactions and pay commissions appropriately. The second on-line merchant site 122 is an example of a website that does not have an in-house affiliate reward program, but participates in a third-party's affiliate reward program. Particularly, the second merchant site provides shopping services in conjunction with a product database and may utilize a web server log analysis to pay out commissions as appropriate.

The customer computer 130 comprises any type of computing device that allows a user (or “customer”) to interactively browse Web sites via the Web browser 132 such as Microsoft's Internet Explorer® or Netscape's Navigator®, which uses the HTTP protocol to communicate with a Web server. In accordance with standard browser technology, the information is displayed in pages such as a content site web page 146. The customer computer 130 may be a personal computer (PC) that runs the Windows NT® or Macintosh® operating system. Alternatively, the computer 130 may be a personal digital assistant (PDA) that has Internet access, a wireless Internet device, or any other type of computing device capable of interfacing with the Internet. In one embodiment, the web browser is configured to accept and provide cookies 134, which could be useful for tracking a user's prior on-line activities for reporting purposes, for example.

The content sites shown at 140 and 141 include any sites that serve web pages to browsers. For example, the first content site 140 includes a web server 142 that serves web pages from a web page database 144 using appropriate computer programs 145. In other words, web pages in the database 144 can be requested, retrieved and viewed by a browser connected to the server 142. A web page 146 in the web page database that utilizes a merchandising system as described herein includes a reserved area 147 for a palette. The HTML code that defines the web page 146 includes code that has a link to the merchandising site that requests a palette and other useful information, such as the originating web site, and the size and orientation of the palette.

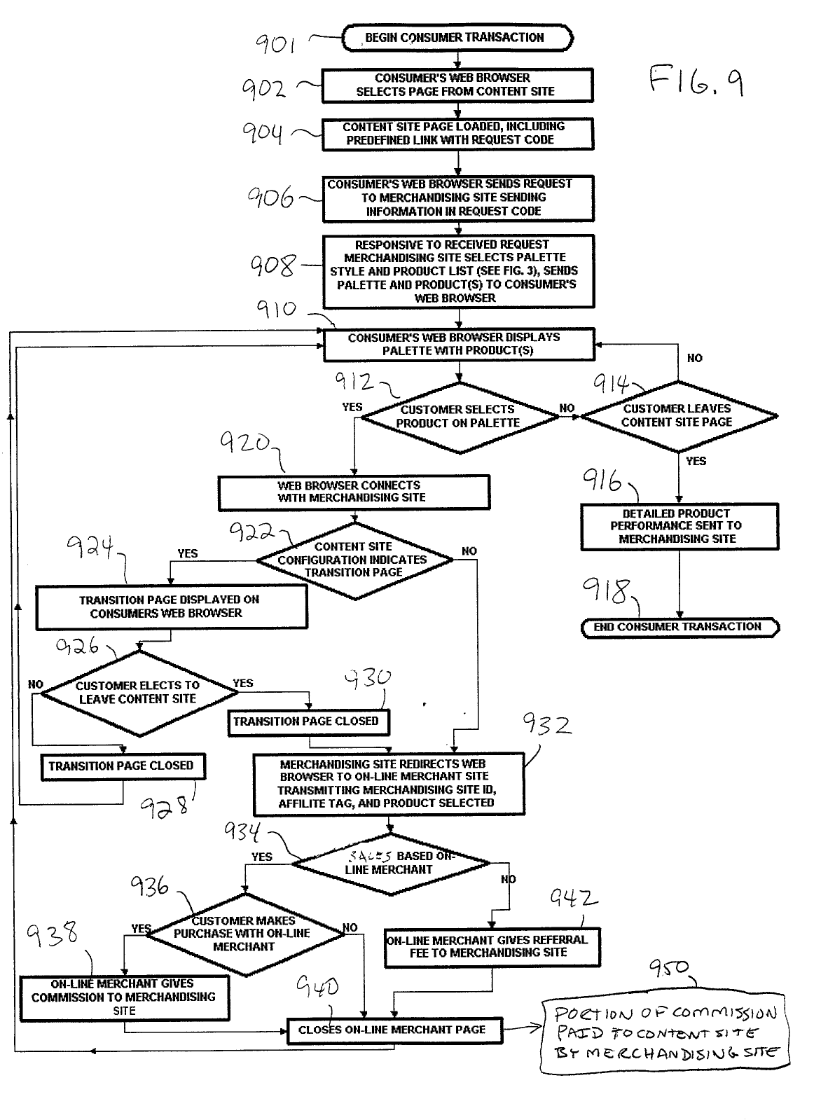

Briefly, in operation when the user loads a content site web page that has an embedded link, the user's browser generates a request for a palette 150 from the merchandising site, which will be inserted into the reserved area 147 on the content site web page. In response, the merchandising site selects the palette style and product list appropriate for the web page, and sends the selected palette style information, product list, and product visual images for display on the web page. Palette style information typically includes palette type, palette size, palette colors, and palette layout. A palette can have a wide variety of formats, such as the palette styles discussed below that include a single-product static palette, a multi-product static palette, and a multi-product dynamic palette. If the user selects a product on the palette, the user (technically the browser) is connected to the on-line merchant's website, which provides a product specific web page 152 relating to the selected product. In one embodiment, such as described with reference to FIG. 9, the merchandising site connects the browser with the on-line merchant, and an optional transition page 154 may be provided to the browser to allow the user to choose whether to leave the content site or not; particularly the transition page includes a link back to the content site shown at 156, and a link to an on-line merchant product specific page shown at 158. In some embodiments, the on-line merchant's web page 152 may be opened as a separate window on the browser, which can provide the user with an easy way to return to the content site web page if desired.

Each palette 150 has a product list from the database 113 associated with it. The product lists can be customized for each page by selected merchandisers using the MOE, as will be described, so that the customized product list is used whenever the content site page requests a palette from the merchandising site. Alternatively, the product list may be selected by another method; for example the merchandising site may select an event-specific product list related to upcoming holidays such as Mother's Day, New Year's Day, and others. For example, if a content site page that does not have a customized product list requests a palette, then a default product list such as the site-specific product list or event-specific product list may be used. A product list can have one or many products; in one implementation a product list has one to ten products. In some embodiments that utilize a multi-product list, information regarding the second product is sent only after a delay period so as not to interfere with other information being loaded by the content page. For example, the second product may not be sent until seven seconds after the first product information has been sent, and then the third and subsequent products follow without delay. In other embodiments the second product may not be sent unless the user requests the next product, and in such an embodiment the merchandising site could respond to the request with the second product.

3. Palettes

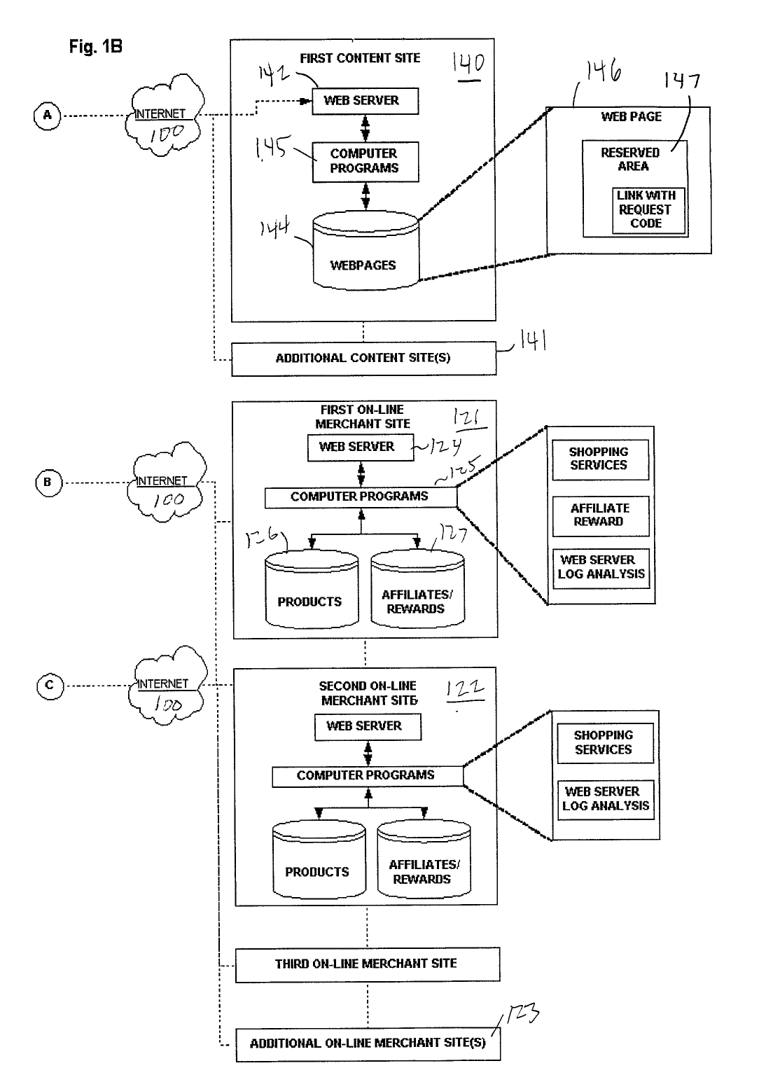

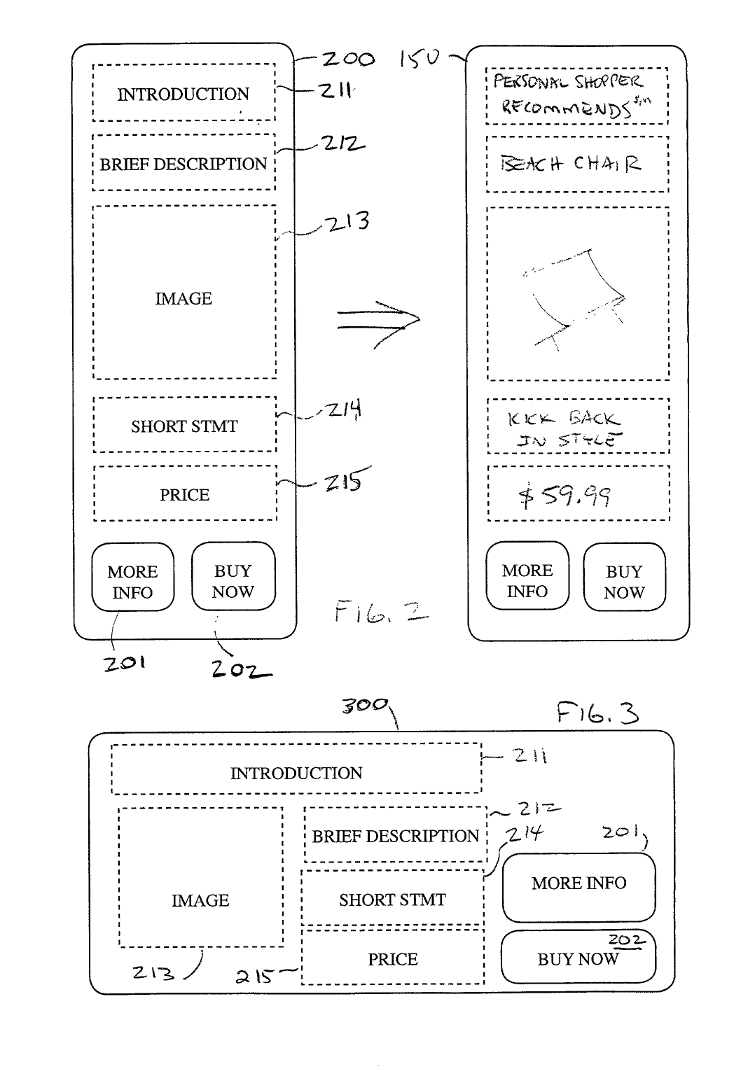

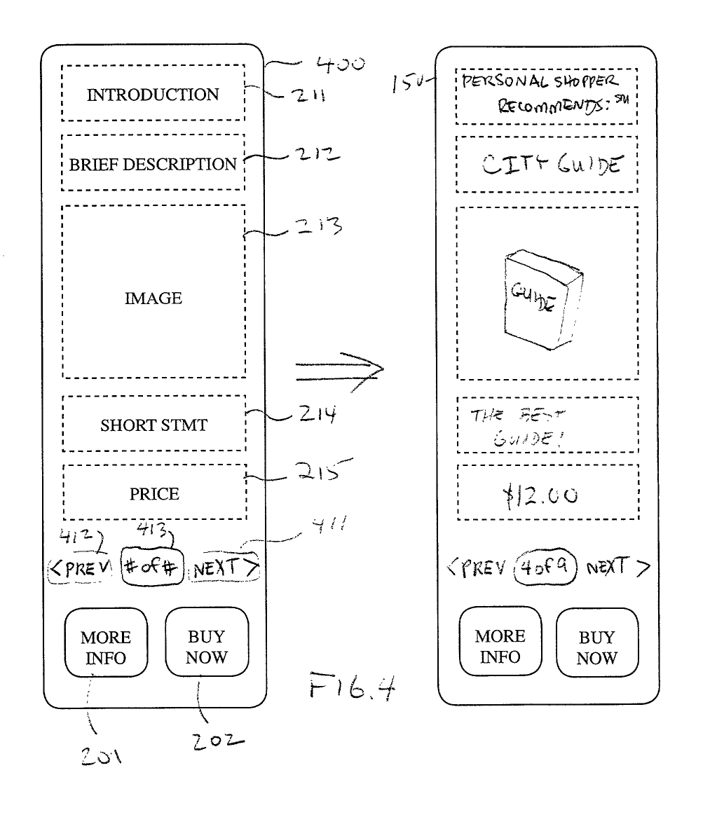

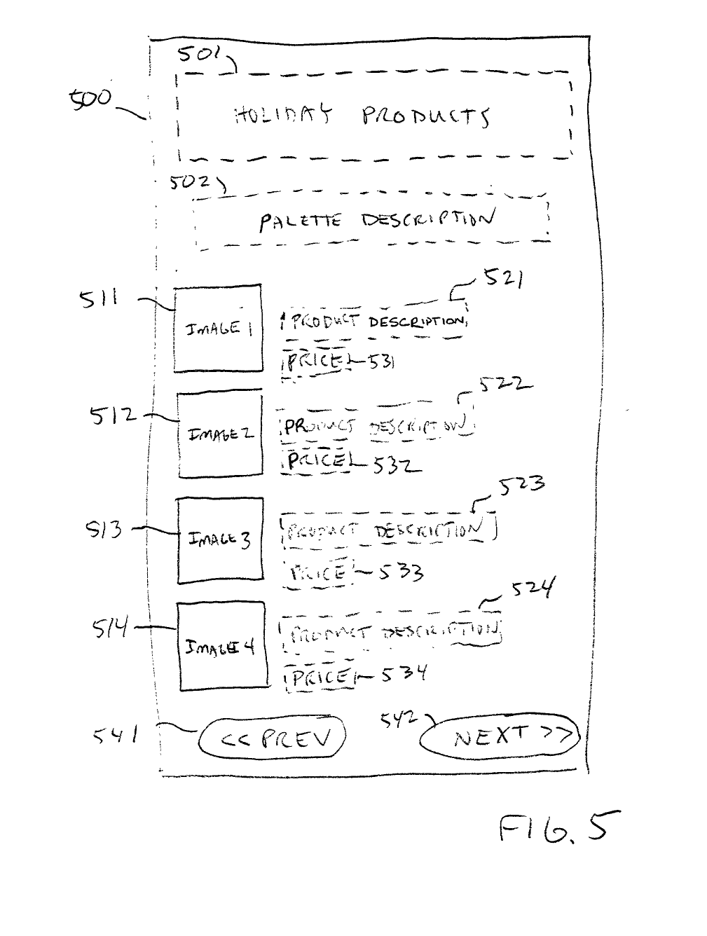

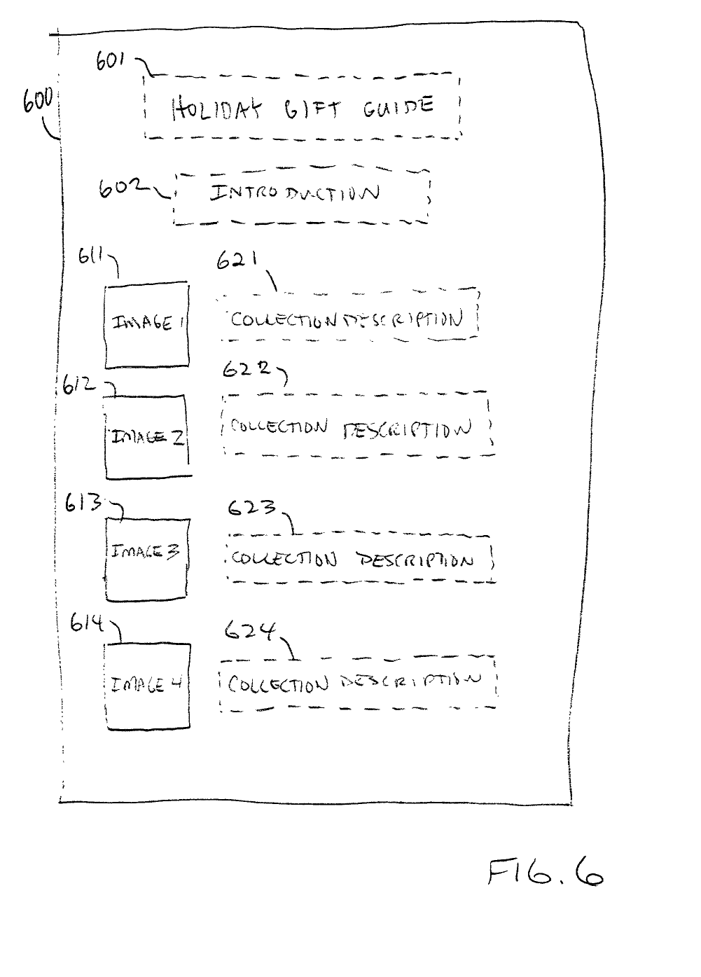

Reference is now made to FIGS. 2, 3, 4, 5, and 6, which show various configurations of the palette 150. Particularly three distinct types of palettes are shown: dynamic, single-product static and multi-product static. FIGS. 2 and 3 show two different configurations of a single-product static palette; particularly FIG. 2 shows a vertical orientation, and FIG. 3 shows a horizontal orientation. FIG. 4 shows a dynamic multi-product palette in the vertical orientation. FIGS. 5 and 6 show multi-product static palettes. The dynamic and single-product static palettes are rectangular in shape and designed to be displayed on content pages. The multi-product static palette is designed to actually be the content page displaying multiple products. It should be recognized that FIGS. 2-6 show examples of palettes; in any particular embodiment the orientation and geometry of the particular palette, as well as the arrangement of information in the palette, can vary greatly. Typically the only visual constraints upon the palettes are based upon practical limitations; for example its rectangular footprint is easily implemented, and the colors are limited by practical concerns to those colors available for web publishing. Furthermore, for the multi-product palettes, the number of products shown depends upon the number of products in the product list.

Each palette 150 typically includes images, short statements, prices, and descriptions of one or more products. These palettes have mechanisms for interacting with the product and/or palette; for example BUY NOW and MORE INFO buttons are seen on the all palettes below. In addition, in some embodiments the product image functions similar to the BUY NOW button. In a dynamic palette, NEXT, PREV buttons are used to scroll between products on the product list. These buttons may be placed anywhere on the palette, visible or invisible, using a wide variety of text describing the functionality of the underlying button. In some embodiments other buttons may be implemented; for example ACTION and ABOUT buttons may provide cross-marketing opportunities by opening configurable URLs when these buttons are selected.

Referring to FIGS. 2 and 3, the single product palettes present product information for a single product (i.e. the product list in a single product palette has only one product). A single product static palette typically has the shortest loading time in comparison with the other types of palettes. A static palette is typically the default palette that is used when the dynamic palette cannot be safely displayed. Also, the single product static palette can be used when specified by the content site client; i.e. when the content site prefers static to dynamic for all users. For example, the content site may wish to minimize the loading time of its page, and therefore the content site may specify a single product static palette. In some implementations, the merchandising site may choose to use a single product static palette when it has been observed over time by the merchandising site that the average viewing time of a content site page is low.

FIG. 2 shows the arrangement of information in one embodiment of single product static palette 200; the palette on the left shows certain regions in dotted lines, on the right the regions of the palette are filled with exemplary information. A MORE INFO button 201 and a BUY NOW button 202 are arranged side-by-side on the bottom of the palette. An introduction 211 is situated at the top of the palette, below that is a brief description region 212 that describes the product in a few words, such as “beach chair”, “straw hat”, and so forth. Directly below the brief description is a visual image region 213, which is typically square to accommodate typical product images. Below the image region 213 is a short marketing statement 214 such as ““the best chair ever”, or “keep the sun off your back”. Below the short statement is the price 215, and directly below the price 215 are user-actuable buttons 201 and 202.

Clicking on the BUY NOW button 202 leads a user to a product page on the on-line merchant's site, and in some embodiments clicking the BUY NOW button 202 leads the user to the on-line merchant's shopping cart with the product already in the shopping cart. In one embodiment the user may first be directed from the user, through the merchandising site, and then to the merchant site in order to ensure that appropriate tracking information (e.g. an affiliate tag) is associated with the user on the merchant site. In other embodiments, if the appropriate tracking information (e.g. affiliate tag) has been provided to the user, the user may directly request the merchant site. In a similar fashion, clicking on MORE INFO button 201 leads the user to the appropriate product page on on-line merchant's site, and clicking on the product image area 213 leads a user to a product page on the on-line merchant's site.

FIG. 3 is an example of a palette 300 that is arranged horizontally rather than vertically as in FIG. 2. In this embodiment, the information in the palette 300 is the same as for the vertical configuration; however other embodiments may utilize more or less information relating to the product. As noted above, in any particular embodiment the orientation and geometry of the particular palette, as well as the arrangement of information in the palette, can vary greatly.

Reference is now made to FIG. 4, which is an example of a dynamic palette 400 that presents product information for multiple products a single product at a time. In FIG. 4, the palette on the left shows certain regions in dotted lines, on the right the regions of the palette are filled with exemplary information. As in FIG. 2, MORE INFO button 201 and a BUY NOW button 202 are arranged side-by-side on the bottom of the palette. Also as in FIG. 2., the introduction 211 is situated at the top of the palette, below that is the brief description region 212 that describes the product in a few words, directly below the brief description is the visual image region 213, below the image region 213 is a short marketing statement 214. Below the short statement is the price 215.

A user interface to scroll through the products on the product list associated with the palette is provided by a NEXT button 411 which selects the next product on the product list, a PREV button 412 which selects the previous product on the product list, and a status display that displays the list number of the currently-displayed product together with the number of products on the lists in the format: <current product> of <total number of products>. If the user wants to see other products on the product list of a dynamic palette, the user selects a “next” or “prev” button available with a dynamic palette. In some embodiments, the palette auto-rotates to the next product every few seconds in sequence, and loops back to the first product when it reaches the end of the list.

If the user chooses to buy the product, or view additional information about the product, the user can click on the BUY NOW button 202, which leads the user to a product page on the on-line merchant's site, and in some embodiments clicking the BUY NOW button 202 leads the user to the on-line merchant's shopping cart with the product already in the shopping cart. In one embodiment the user may first be directed from the user, through the merchandising site, and then to the merchant site in order to ensure that appropriate tracking information (e.g. an affiliate tag) is associated with the user on the merchant site. In other embodiments, if the appropriate tracking information (e.g. affiliate tag) has been provided to the user, the user may directly request the merchant site. In a similar fashion, clicking on MORE INFO button 201 leads the user to the appropriate product page on on-line merchant's site, and clicking on the product image area 213 also leads a user to a product page on the on-line merchant's site.

In summary, in one embodiment a dynamic palette displays one or more products where the user may interact either with the palette itself or the product with the primary intent of purchasing the product or acquiring more information about it. Secondary and tertiary intents may include learning more about the palette through the ABOUT or ACTION button (not shown). For example, an ABOUT button (placed underneath the descriptive title “Personal Shopper Recommends”) could send the user to an informational page about the merchandising site's services. An ACTION button, which can be placed anywhere on the palette, could send the user to another location on the content site.

Reference is now made to FIGS. 5 and 6. At least two types of multi-product static palettes are described herein: FIG. 5 shows is a first type of multi-product static palette in which product information is displayed for multiple products at the same time, and FIG. 6 shows a gateway page that has hyperlinks to other product palettes or other gateway pages.

FIG. 5 shows a product page 500 as seen by the user's browser. The product page is another style of multi-product static palette displaying product images and description for one or more products on a single page. Although in some embodiments the product page may be large enough to fill an entire displayed page, it can still be considered a palette. The product page 500 shown in FIG. 5 includes a title bar 501 that indicates an event or other subject, such as “Mother's Day Gifts” “Christmas Gifts”, and so forth. Below the title bar is an optional palette description 502 that includes a brief description such as “Gifts under $25” “Gifts between $25 and $50” and so forth. The product information for each product includes an image shown respectively at 511, 512, 513, 514, a product description shown respectively at 521, 522, 523, and 524, and a price shown respectively at 531, 532, 533, and 534. Each product includes links to the product via clicking on the image itself or optionally a BUY NOW or MORE INFO button (not shown) that operates as described above for a single-product palette. FIG. 5 shows four products as an example; any particular embodiment of a product page may include more or less products.

In some embodiments, such as described with reference to FIG. 6, the product page may be a member of a collection of related products. For example, a collection of related Mother's Day products may include a page of “Gifts under $25”, “Gifts between $25 and $50”, Gifts between $50 and $100”, and “Gifts over $100”. If the product page is a member of a collection of related products, the page will include navigational buttons including a PREV button 541 and a NEXT button 542 to navigate between the other product pages in that collection of related products.

FIG. 6 is an example of a gateway page 600, which is a style of static multi-product palettes. The gateway page serves as a pseudo table-of-contents for a broad range of products that can be found inside collections of static multi-product palettes with related products, such as the product page shown in FIG. 5. The gateway page 600 includes a title bar 601 that indicates an event or other subject, such as “Mother's Day Gift Collections” “Christmas Gift Collections”, and so forth. Below the title bar is an optional description 602 that includes a brief description such as “Gifts for All Budgets”. The gateway page describes each collection of related products and may display an image and description of the first product of each distinct collection. As shown in the palette 600, the information for each collection includes an image shown respectively at 611, 612, 613, 614, a collection description shown respectively at 621, 622, 623, and 624, and a price shown respectively at 631, 632, 633, and 634. Each collection includes links to the related product page via clicking on the image itself. FIG. 6 shows four collections as an example; any particular embodiment of a product collection may include more or less collections.

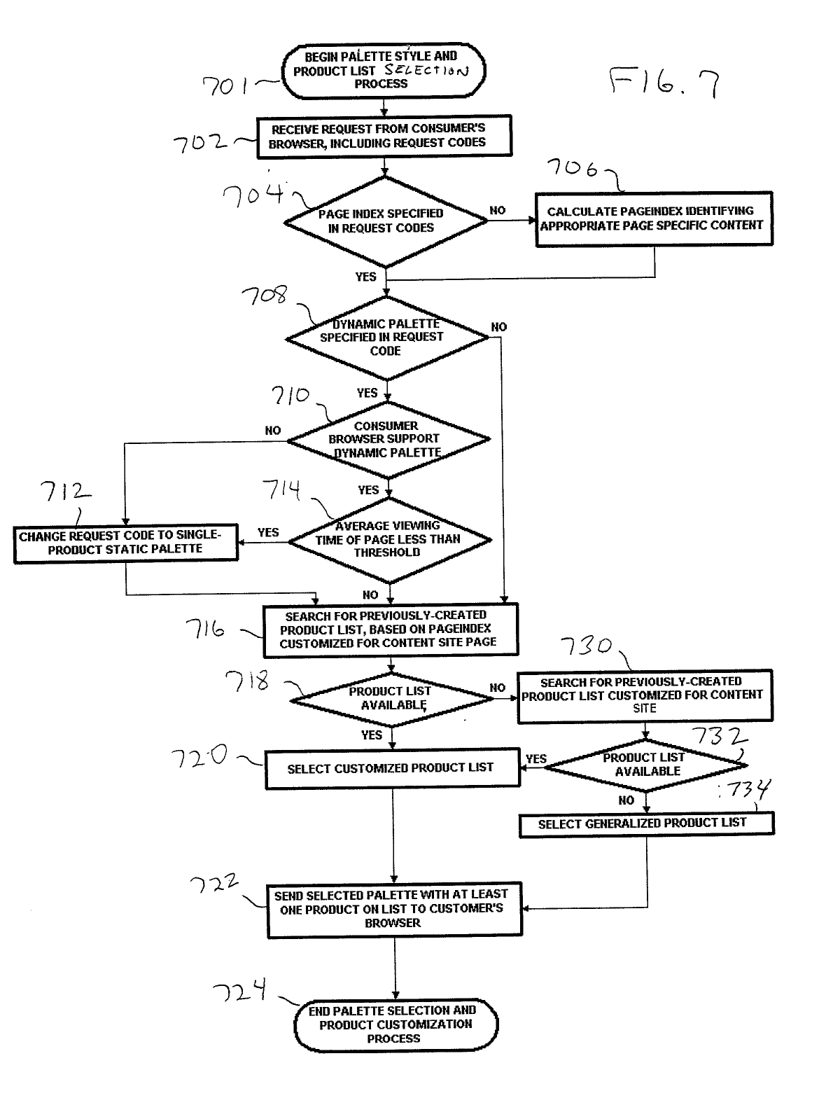

Reference is now made to FIG. 7, which is a flow chart of operations in one embodiment to select a palette and product list by the merchandising site 102 (FIG. 1A) in response to a request from a user browser 132. At 701 operations begin to select a palette style and product list. At 702, a request is received from the consumer's browser 132, including request codes. These request codes typically include predefined information, including at least an identification of the content site that initiated the request, and palette size and layout information. In one embodiment, the request code optionally includes a page index, which is a way to refer to a product list in one embodiment.

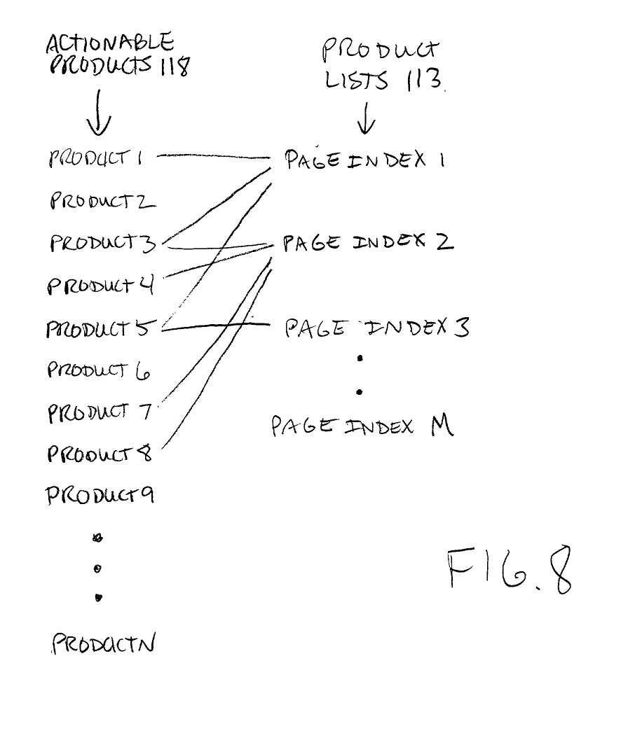

Reference is briefly made to FIG. 8, which is a diagram illustrating the association between the page index in the products lists database 113, and the products in the actionable products database 118 in one embodiment. The products in the actionable products database are labeled product 1, product 2, . . . , product N, and the product lists 118 are labeled page index 1, . . . , page index M. In this example, the page index 1 is associated with products 1, 3, and 5. The page index 2 is associated with products 3, 4, 7, and 8, and the page index 3 is associated with only one product, which is product 5. The association of the page indexes with products is done by merchandisers in the merchandising site described herein, dependent upon factors such as the context of the content site's page that requested the palette.

In one embodiment, the Palette Serving Engine uses a page index to characterize the content of an individual content site page or a set of related content site pages. In this example, the merchandising site provides the content site with the optional page index (termed “PageIndex”), as part of the request codes included in the predefined link for insertion in their web pages.

If a PageIndex is specified in the predefined link's request code, then that PageIndex has been assigned to a specific type of content. For example, the PageIndex “Chargers” or “67” can be assigned to content based on the San Diego Chargers football team by either the content site or by the merchandising site. The content site would then include this PageIndex in the request code for those content web site pages pertaining to the Chargers. Each content web site page including this PageIndex would be served the same palette-a collection of products and services appropriate for San Diego Chargers fans. If the PageIndex contains a leading ‘s’, a single product static version of the palette is displayed versus the default dynamic palette.

Referring again to FIG. 7, at 704, if a page index is specified in the request codes, then operation moves to the next step 708. However, if page index is not specified, then at 706 a page index is calculated identifying appropriate page specific content. In one example, if a PageIndex is not specified in the predefined link's request code, the PageIndex is calculated using one of three distinct algorithms. The Merchandising Startup Component of the Palette Serving Engine 1010 identifies which algorithm to use for calculating the PageIndex based on the content site. In one implementation, a given content site can only use one of these algorithms:

1) The first algorithm is a hash algorithm based on the content site page URL including any parameter values. Prior to calculating a hash value, this algorithm preprocesses the input URL to eliminate the basename prefix of the URL, ensure all characters in the URL are lowercase, and eliminate those common default page names that begin with default, welcome, and index. As an example, the content site page URL “www.merchandisingavenue.com/contentarea1/default.html?mid=123456” is trimmed to “contentarea1?mid=123456”. This trimmed URL is then used to calculate the PageIndex based on the following algorithm:

tempvalue = 0
pageindex = (length of trimmed URL)
for (each character in the trimmed URL)
{

tempvalue = tempvalue + ((ascii value of the current character)

* (char position in URL − 1)) + ((char position in URL -1) * 7) ;

if (tempvalue < 0 or tempvalue > 10000)

{

pageindex = pageindex + (pageindex * 10000) + tempvalue
tempvalue = (char position in URL − 1);

}

```
  }
  if (length of trimmed URL = 1) pageindex = 256;
  else pageindex = pageindex + tempvalue
```

+ ((ascii value of the last character)*2);

2) The second algorithm is the hash algorithm based on the content site page URL excluding any parameter values. The hash algorithm used is the same for the first algorithm simply with different inputs to the hash algorithm. Thus, the trimmed URL for the above example would be “contextarea1” for the second algorithm.

3) The third algorithm extracts the PageIndex from the first parameter value on the content site page URL.

After the page index is determined, then the type of palette (e.g. dynamic or static) is determined. At 708 the request code is examined to determine if a dynamic palette has been specified by the content site in the request code. If not, then a static palette is assumed and operation skips to 716. However, if a dynamic palette has been specified, then the consumer's browser is queried by the merchandising site to determine if the appropriate software (e.g. Java, Flash, Microsoft Common Language Runtime, and/or DHTML) is supported on the browser. If not, then at 712 the request code is changed to single-product static palette. However, if at 710 the consumer's browser supports dynamic palettes, then a determination is made as to whether the average viewing time per page of the content site (as observed by the merchandising site previously) is less than a certain threshold that would suggest that the user will stay on that page for only a short period of time (e.g. several seconds). If the average viewing time is less than threshold, then at 712 the request code is changed to single product static palette. If however the average viewing time is greater than or equal to threshold, then a dynamic palette is indicated and operation moves on.

At 716, a search is made for a previously-created product list, based upon the page index, previously customized for the content site. At 718, if such a product list is available, then the customized product list is selected at 720, and at 722, the selected palette is sent to the user's browser with at least one product on the list. However, at 718, if the product list is not available, then at 730 a search is made for a previously-created product list, based on the content site. At 732, if a previously-created list is available, then at 720 the previously-created list is selected, and then sent at 722. However, at 732, it a previously-created list is not available, then a generalized product list 734 is utilized, such as a default product list or an event specific product list, such as a product list for Mother's Day, and sent to the user's browser at 722. At 724, operations are complete.

4. Consumer Transaction Example

Reference is now made to FIG. 9, which is flow chart of consumer transaction operations in one embodiment. Operation begins at 901, and assumes that the consumer is on-line. At 902, the consumer's web browser selects a page from the content site. At 904, the page is loaded, including a predefined link with a request code. At 906, the consumer's web browser sends a request to the merchandising site, including information in the request code placed therein by the content site. At 908, responsive to the received request, the merchandising site selects a palette style and product list (such as previously described with reference to FIG. 7), and sends the palette and product(s) to the consumer's web browser. At 910, the consumer's web browser displays the palette with one or more products.

At 912, a determination is made if the customer selects a product on the palette. If the customer has not yet selected a product, then at 914, if the customer has not yet left the content site page, then operation continues through the loop 910 to 912 to 914. If at 914 the customer leaves the content site page, then at 916, in some embodiments detailed product performance is sent to the merchandising site, such as length of time the page was displayed, the length of time that the held the cursor over the palette. Operation then ends at 918.

Returning to 912, if the customer selects a product on the palette, then at 920 the user's web browser connects with the merchandising site. If at 922 the content site configuration (or the request codes) indicates that a transition page is not desired, then at 932 the merchandising site redirects the web browser to the on-line merchant's site, transmitting information such as the merchandising site ID, affiliate tag, and product selected, and in response the merchant will transmit the product specific web page 152 (FIG. 1A). However if at 922, the content site indicates that a transition page is desired, then at 924 a transition page 154 (FIG. 1A) is displayed on the user's web browser. If at 926 the customer does not elect to leave the content site, then at 928 the transition page is closed, and operation returns to 910 where the consumer's web browser continues to display the palette on the content site web page. However if at 926 the customer elects to leave the content site, then at 930 the transition page is closed and at 932 the merchandising site redirects the web browser to the on-line merchant's site, transmitting information such as the merchandising site ID, affiliate tag, and product selected, and in response the merchant will transmit the product specific web page 152 (FIG. 1A).

The payment of a commission by the on-line merchant is dependent upon its relationship with the merchandising site. At 934, if the relationship is based upon sales, and at 936 the customer makes a purchase with the on-line merchant, then the on-line merchant gives the sales commission to the merchandising site. However if the relationship is not based upon sales, then at 942 the on-line merchant gives a referral fee (commission) to the merchandising site. Then at 940 the user closes the on-line merchant page, and at 950 a portion of the commission received from the merchant is paid to the content site by the merchandising site by any suitable system, such as electronic transfers on a regular basis (or checks on an irregular basis). The portion of the commission payable to the content site is determined by the particular business arrangement between the merchandising site and the particular content site; for example the business arrangement may provide for payment of a certain percentage of the commissions attributable to the content site, or a graduated scale of percentages, or a fixed fee per sale, or any other suitable arrangement.

5. Overview of Computer Program Systems

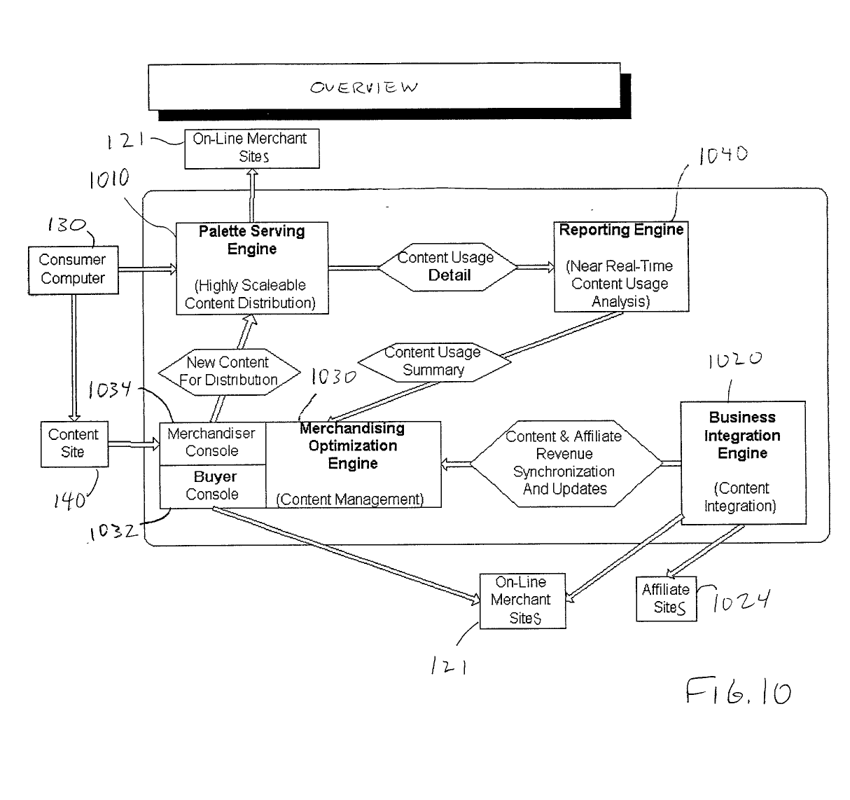

FIG. 10 is a high-level system block diagram of one embodiment of a merchandising site 102 shown in FIG. 1A, showing interactions between four computer programs (termed “engines” herein), including a Palette Serving Engine (PSE) 1010, Business Integration Engine (BIE) 1020, the Merchandising Optimization Engine (MOE) 1030, and the Reporting Engine (RE) 1040. Each will be described in detail for this embodiment. Briefly, the PSE 1010 interacts with a consumer computer 130 and an on-line merchant site 121. New content sites and products selected by the MOE 1030 are provided to the PSE, and the content usage of the consumer observed by the PSE is supplied to the RE 1040, which in turn reports this information in summary form to the MOE 1040. The MOE includes a buyer console 1032 that utilizes an on-line merchant site 121 to provide and update product information. One purpose of the buyer console is to provide an interface and decision-making tools for a Buyer to select actionable products. The MOE also includes a merchandiser console 1 034 that interacts with content sites and provides new content and product lists to the PSE 1010. A Merchandiser utilizes the merchandising console for purposes such as selecting which of the actionable products will be marketed on a palette on a web page of a content site. The BIA 1020 interacts with the MOE to provide content and affiliate revenue synchronization features between the databases in the merchandising site, the product databases on the on-line merchant site(s) 121, and third party affiliate programs at third party affiliate sites 1024.

6. Palette Serving Engine

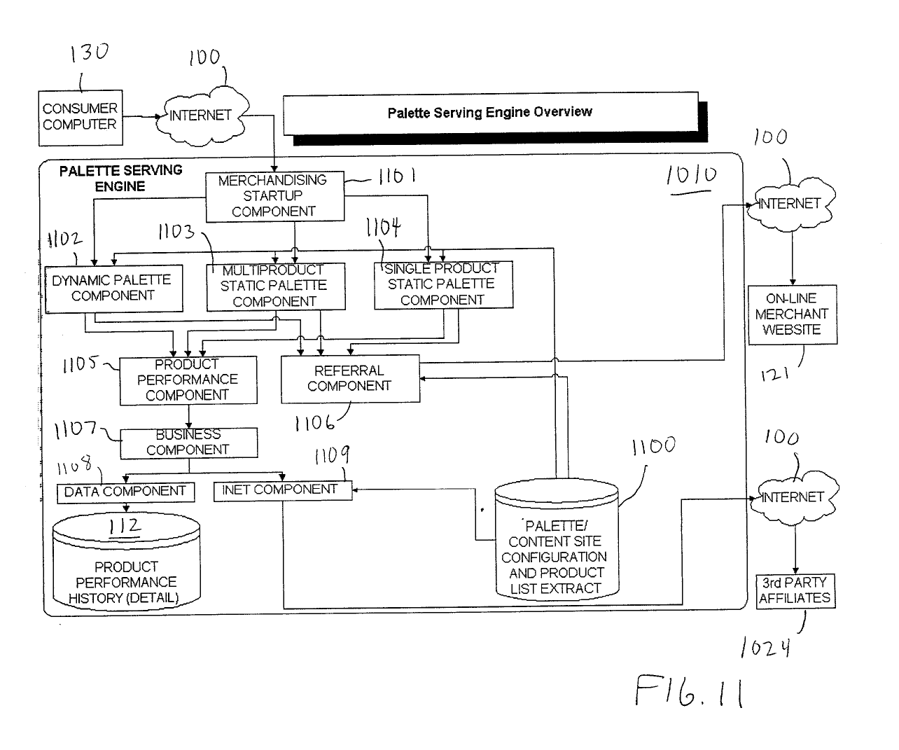

FIG. 11 is a block diagram of one embodiment of a Palette Serving Engine (PSE), each component of which is described in detail below, which draws information from a grouped database 1100 that includes information regarding palette configuration 114 (FIG. 1A), content site configuration 115, product lists 113, and event-specific product lists 116. Briefly, the PSE includes a Merchandising Startup Component 1101 that is connected via the Internet 100 with a consumer computer 130. The Merchandising Startup Component 1101 selects either a Dynamic Palette Component 1102, a Multiproduct Static Palette Component 1103, or a Single Product Static Palette Component 1104, as described elsewhere herein. The chosen palette provides detailed product performance information to the Product Performance Component 1105 and product selection information to the Referral Component 1106. The Referral Component 1106 receives information from the grouped database 1100, and forwards the consumer browser 132 to the on-line merchant website 121 via the Internet 100. The Product Performance Component 1105 passes the detailed product performance information to the Business Component 1107, which forwards this information to a Data Component 1108 and an Inet component 1109 as appropriate. The Data Component 1108 records this information to the Product Performance history database 112. The Inet Component 1109 using information from the grouped database 1100, supplies information to third party affiliates 1024, if requested. Each of these components is discussed in detail below.

Merchandising Startup Component 1101: This component is responsible for examining the consumer's computer environment and the palette request link embedded in the content site page. Based on these factors, the component determines the appropriate page index algorithm to be used, and palette type to be displayed.

Dynamic Palette Component 1102: This component displays multiple products a single product at a time based on a defined product rotation. Each product is displayed over a background image designed to complement the content site design. These products are rotated on a periodic basis or when the consumer selects “previous” or “next” buttons available on the background image. While the palette is displayed, detailed product performance data is collected and as the consumer leaves the content site page this data is delivered to the Product Performance Component. When a consumer selects the product image, “buy” button, or “info” button the Referral Component is notified.

Multi Product Static Palette Component 1103: This component displays multiple products at a time on a single page. Placement of these products is based on a defined product rotation. When the palette is displayed product performance data is delivered to the Product Performance Component. When a consumer selects the product image, “buy” button, or “info” button the Referral Component is notified.

Single Product Static Palette Component 1104: This component displays a single product over a background image designed to complement the content site design. When the palette is displayed product performance data is delivered to the Product Performance Component. When a consumer selects the product image, “buy” button, or “info” button the Referral Component is notified.

Product Performance Component 1105: This component collects product performance data from each of style of palette, validates the data against a XML schema, and places the data on a queue for processing by the Business Component.

Referral Component 1106: This component is notified when the consumer selects the product image, “buy” button, or “info” button. This component forwards the consumer's browser to the appropriate product level page on the on-line merchants site based on the button selected. In addition, this component populates the “referred by” attribute of the HTTP protocol—allowing the on-line merchant to confirm the merchandising site delivered the consumer to the on-line merchant's site.

Business Component 1107: This component examines transactions placed on the queue by the Product Performance Component and determines proper transaction routing. All transactions are passed to the Data Component. Those transactions based on the consumer clicking on a product of an on-line merchant participating in a third-party affiliate program are also passed to the Inet Component.

Data Component 1108: This component persistently stores the product performance data into the database.

Inet Component 1109: This component notifies third-party affiliate programs, if the third-party affiliate program requires notification, whenever a product is selected for an on-line merchant that is a member of that affiliate program.

In operation of one embodiment, a content site 140 (FIG. 1A) embeds two lines of HTML code into its web pages so the PSE can serve a predetermined palette. The HTML code calls a Jscript script in the merchandising site, and then communication begins between the user and the merchandising site. The Palette Serving Engine serves either a multi-product static palette (which presents numerous products), or a single-product static palette (which presents only a single product) or a dynamic palette (containing numerous products), depending on the request codes in the two lines of embedded HTML code and the client's browser configuration. Specifically if a static palette, either multiple-product or single-product, is specified in the request code the appropriate static palette is called. Otherwise, if the user browser is determined to be Java-enabled, then a dynamic palette is called by the PSE, if not a static palette is called. For a dynamic palette, the palette configuration is loaded first, and then the background and image for the first product is loaded. After about eight seconds the remainder of the product images are loaded. Typically less than 25K of memory is necessary to display the first product. If the consumer clicks on the product, 1) a daughter window is opened on the user's browser with the on-line merchant's product page, and 2) this information is sent back to the merchandising site. When the user closes the browser, palette summary information is sent back to the merchandising site, including information such as how many times the next and previous buttons were pushed, hover times, and how many products were displayed.

7. Reporting Engine

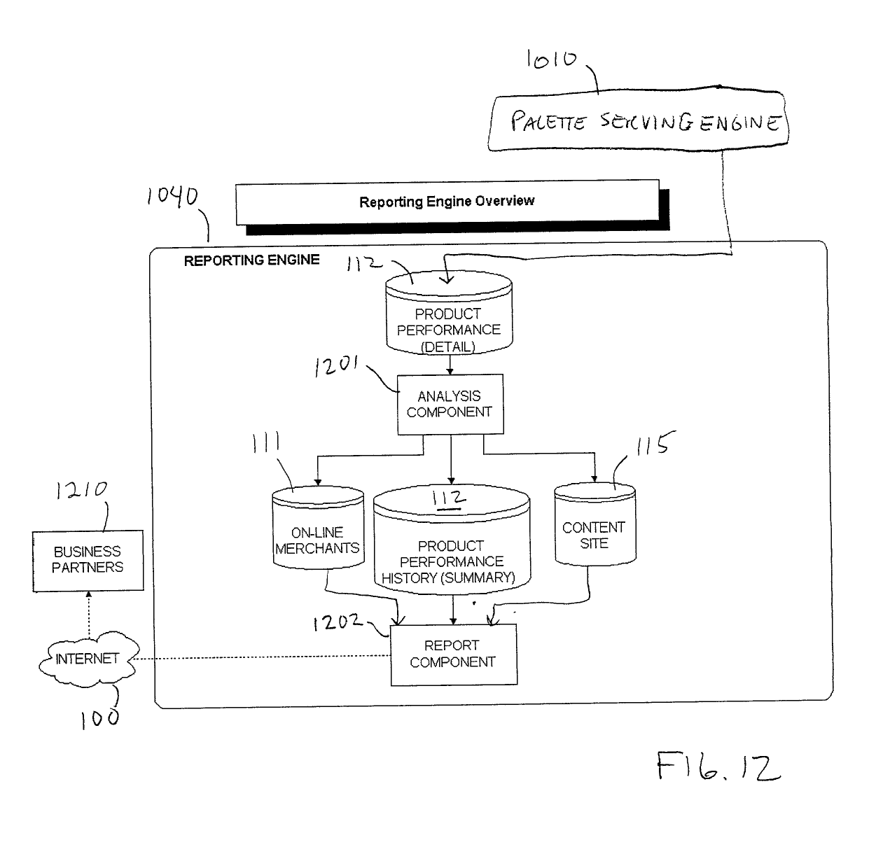

FIG. 12 is a block diagram of one embodiment of a Reporting Engine (RE) 1040. As previously discussed, the PSE 1010 collects information based on user's actions with regard to the palettes and products thereon, such as number of click-throughs, the amount of time each product is viewed, hover time, and so forth, and stores this detailed product performance information in the product performance database 112. An Analysis Component 1201 retrieves this information stored in the product performance database 112 by the PSE 1010, and produces summarized product information stored in the product performance database 112 for use by the Reports Component 1202 to provide reports. For example, the Analysis Component collects and correlates data points such as click-through rates, product price points, for purposes such as determining which products are selling well online across various audiences. In one embodiment the Analysis Component 1201 executes on a periodic basis where the period may be either time based, every x minutes, or transaction based, every x number of detailed product performance transactions. During execution, the Analysis Component 1) collects all detailed product performance transactions occurring during the previous period, 2) summarizes the information based on content site, content site page, palette, product, product category, and on-line merchant, 3) stores this information as a summary product performance transaction, 4) when appropriate, pushes the summary product performance transactions to a central server for report generation, 5) notify the Merchandising Optimization Engine of the arrival of new content site pages, and 6) notify the Merchandising Optimization Engine of product performance on an content site, content site page, and palette basis.

Because the PSE 1010 can report its information in real-time, the RE 1040 can quickly process its information and supply its reports in near real time. In one embodiment, several reports can be generated: 1) on-line merchant performance which can be stored in the on-line merchant database 111, 2) product performance which can be stored in the product performance database 112, and 3) content site performance which can be stored in the content site database 115.

In the first report (on-line merchant performance), information regarding the on-line merchant performance is collected within and across content sites and content categories on the web. For example, click-through rates to the on-line merchant can be summarized and processed, to provide information such as raw numbers and percentages. In the second report (product performance), product performance is collected within and across content sites, content pages and content categories on the web. This information can be useful, for example product lists can be changed by a merchandiser, in near real-time based on the merchandiser's analysis of a product's individual performance based on click-through rates. Furthermore, this information can be used by a merchandiser to determine which brands, categories and types of products are appealing to each audience. In the third report (content site performance), content site, content page and content category performance are reported. This information can be used, for example to discern which products appeal to specific audiences within a particular site and which products appeal to the site's audience overall. Impressions and click-through rates can be reviewed in order to optimize each page containing a palette supplied by the merchandising site.

A Report Component 1202 is connected to retrieve and present report information from the on-line merchants database 111, the product performance history database 112, and/or the content site database 115. To a merchandiser, buyer, or other authorized persons or entity, such as a business partner 1210 who connects to the RE via the Internet 1000, the Report Component 1202 presents a menu of available report types (content site, on-line merchant, product performance) on a web page made available to the merchandising site and its business partners. When a report type is selected in one example, a calendar is displayed indicating the time periods summary product performance transactions are available for the requested report type. When a reporting period is selected in one example, a Microsoft Excel® spreadsheet is created on the desktop with one sheet containing detailed records based on the summary product transactions from that reporting period and a second sheet containing a pivot table appropriate for the report type requested.

8. Business Integration Engine

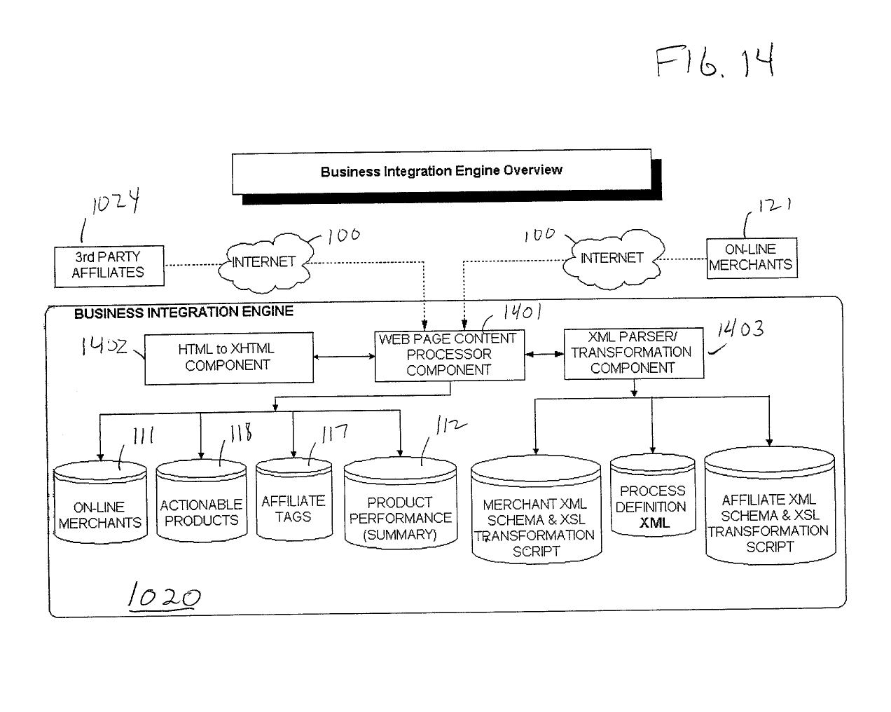

The Business Integration Engine (BIE) 1020, shown in FIG. 14 in block form, includes features to automatically synchronize and update information from websites with local databases. These features are used to support these two functions of the BIE 1020: 1) synchronizing the actionable products database 118 (FIG. 1A) at the merchandising site with the product database for each on-line merchant that has a corresponding product. Therefore, on-line merchants have only to update their own web site, and the new product information will be automatically included in the merchandising site database, thereby making it unnecessary for the merchant site to notify the merchandising site of any product changes and 2) synchronizing the product revenue portion of the actionable product database at the merchandising site with the revenue reports available from each on-line merchant website(s) 121 and third-party affiliates website(s) 1024.

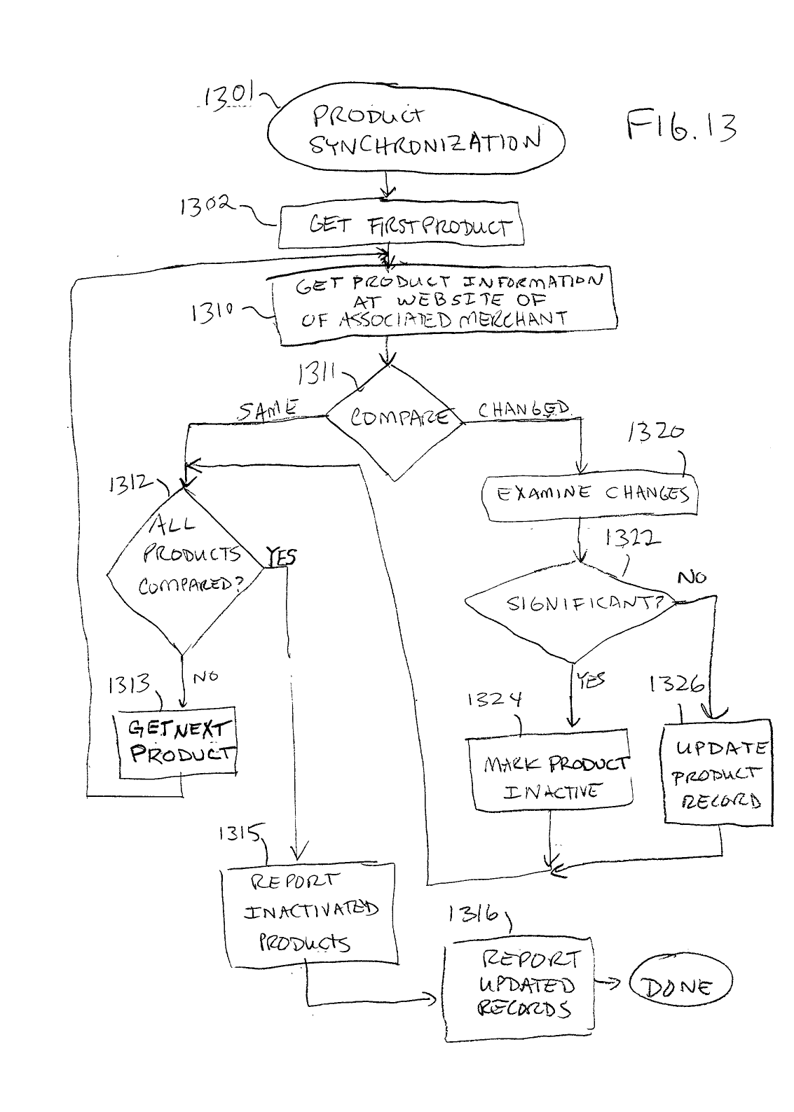

FIG. 13 is a flow chart of operations in one embodiment to synchronize the actionable products database 118 with the product databases of the on-line merchants. The process begins at 1301, and at 1302 the “Smart Tag” is retrieved for the first product record selected in the actionable products database. At 1310, the BIA connects with the website of the associated on-line merchant and retrieves the corresponding product information from the merchant's website. At 1311, this product information is compared with the product information embedded in the product's “Smart Tag”. If the product information is the same, then at 1312 a determination is made if all actionable products have been compared. If products remain to be compared, then at 1313 the “Smart Tag” for the next product record is selected, and then operation returns to 1310 to connect with the merchant's website and retrieve the product information for the next product, and continues as before. However, if at 1312 all products have been compared, then at 1315 the list of inactivated products is reported to the appropriate entity or person. Optionally, at 1316, the list of updated products may be reported to an appropriate entity or person. In one embodiment the inactivated products are reported to the buyer console of the MOE, where each product is examined to determine if the product will be discontinued or maintained as modified. Accordingly, the actionable products database 118 is regularly purged of incorrect data or discontinued products.

If at 1311, the comparison between the product record at the merchandising site and the merchant's site indicates that the information has changed in any way, then at 1320 the changes are examined using predetermined criteria. If the results of 1320 indicate that the changes are significant, then at 1324 the product will be marked inactive. The measure of “significance” at 1322 varies between embodiments; but generally suggests that something has changed enough to warrant removing it from the actionable products list. Examples of significant changes may include: 1) the merchant's web page no longer exists, 2) the product's web page has changed so significantly that the BIA cannot parse the information to extract the product information; 3) more than one field of information has changed (e.g. both name and price have changed) and 4) one field's change exceeds predefined boundaries (e.g. the price has increased by 25% or more).

If at 1322, it is determined that the changes are not significant, then at 1326 the product records are updated. From either 1324 or 1326, operation moves to 1312 to determine if all actionable products have been compared, and then proceeds as described above.

FIG. 14 is a block diagram of one embodiment of a BIE 1020, including a Web Page Content Processor (WPCP) Component 1401 that is connected to the on-line merchants database 111, the actionable products database 118, the affiliate tags database 117, and the product performance database 112. The main component for the Business Integration Engine, the WPCP 1401 is primarily responsible for providing the implementation for several custom XML tags. Custom XML tags have been created to define steps in a process, conditional looping, inserting and retrieving information from databases, executing batch command files, retrieving XHTML from a Uniform Resource Locator (URL), and applying XML schemas and XSL transformation to XML streams. On execution the WPCP reads a process definition xml file identifying the process appropriate for processing the desired type of web pages. Thus, there is one set of process definition xml files that drive the “Product Synchronization” process and another set of process definition xml files for driving the “Revenue Reporting” process. These process definition xml files utilize these custom tags to define the process necessary to process those pages with WPCP providing the implementation for the custom XML tags.

HTML to XHTML Component 1402: Given a URL, this component retrieves the HTML for that URL, applies a set of heuristics to ensure the HTML is well-formed, and then transforms that HTML into well-formed XHTML. This functionality is available by a third-party software component.

XML Parser/Transformation Component 1403: Given a well-formed XML file, this component will map the contents of the file to a XML schema and apply XSL transformation scripts to that XML file. This functionality is available as a third-party software component.

### Smart Tags

In one embodiment the Merchandising site uses “Smart Tags” to collect product information for use by the Merchandising site (collection), and ensure the information remains consistent with the current published product information on the on-line merchant's site (synchronization). Smart tags are generated in the Pick 'N Click feature of the MOE, described subsequently that “tags” the product.

In one embodiment, a “Smart Tag” is a collection of XML attributes, where each attribute has a first custom XML tag for the information tagged, and a second custom XML tag (“XSLSyncFile”) which defines how to maintain those attributes. In one embodiment the Merchandising site uses the following XML tags/attributes: <eMer_ProductID>—reference to the specific product in the actionable products database 118, <ProductURL>—reference to the on-line merchant product specific web page 153, <eMer_eMerchantID>—reference to the specific on-line merchant selling this product, and <SellingPrice>—the current product price as represented in the actionable products database 118. In this embodiment, the above XML tags with the <XSLSyncFile“tag represent the entire “Smart Tag”.

In one embodiment the BIE 1020 collects information using the “Smart Tags”. In this collection process, in an automated manner, the HTML representing the on-line merchant product page is retrieved from the on-line merchant's site and converted into XHTML format. The on-line merchant product page, represented in XHTML format, is then processed with the custom XSL script named in the <XSLSyncFile> tag of the “Smart Tag”. The XHTML version of the on-line merchant product page contains XML tags that are compared by the XSL script with those custom XML tags embedded in the XSL script. The XML output resulting from executing the XSL script contains the collected information of interest from the product page and the custom XML tags with the Jscript and SQL commands necessary to synchronize the information collected from the product page with the database.

The BIE 1020 is also responsible for “synchronizing” the information associated with “Smart Tags”. The Business Integration Engine reads the XML generated above when applying the XSL script and compares the product information retrieved from the on-line merchant site with the product information available in the “Smart Tag”. If a significant difference is encountered, the Jscript and SQL commands embedded in the XSL are executed to update the product information in the actionable products database if necessary, as described with reference to the flow chart of FIG. 13.

If the appropriate XSL script has not been identified for the specific product page being processed, the XSL library is searched for an XSL script using the same XML tag names as the XHTML version of the product page. The selected XSL script is applied to the XHTML and if the information retrieved matches the information collected when the product was profiled, the selected XSL script is assigned to that product page. If the XSL library does not contain a valid XSL script for a specific product page, the product is inactivated until a valid XSL script is created for that product page.

The above description shows one use of “Smart Tags” for managing merchandising information. However, this technology has significantly broader application. For example, the same technology/approach, using tags appropriate for the problem domain, can be extended to provide a generalized solution for identifying Internet/Intranet content and synchronization of that content with any database.

9. Merchandising Optimization Engine

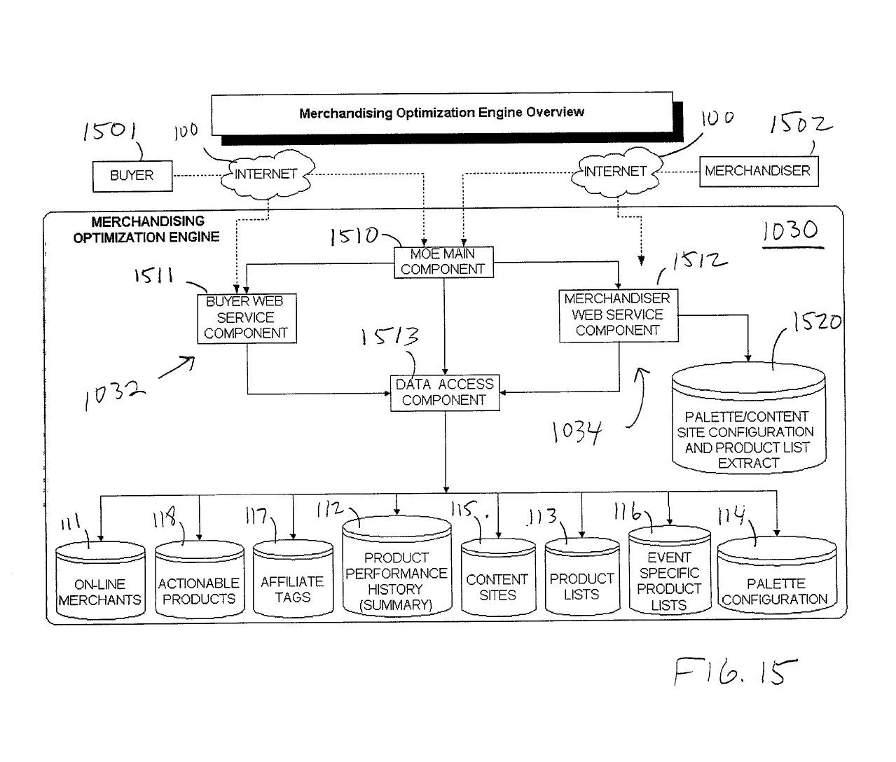

FIG. 15 is a block diagram of one embodiment of a MOE 1030. The MOE is used by Buyers 1501 and Merchandisers 1502, who access the MOE 1030 through a secure interface provided by an MOE Main Component 1510. A Buyer is one who has primary responsibility for on-line merchants, product information, selecting actionable products, and can be assigned to specific on-line merchants. A Merchandiser is one who has primary responsibility for content sites and product lists, including merchandising actionable products using the content sites, and creating palettes and product lists, and can be assigned content sites. The Buyer interfaces with the MOE 1030 via the Buyer Console 1032 which is a menu (or a series or menus) and the Merchandiser interfaces with the MOE 1030 via the Merchandising Console 1034 which is also a menu (or a series of menus). In one embodiment, a main menu is used to access the Buyer Console 1032 and the Merchandising Console 1034. One purpose of the Buyer Console is to provide an interface and decision-making tools for a Buyer, who selects the actionable products in the actionable products database 118 that will be made available for sale by a Merchandiser. The Merchandiser utilizes the Merchandising Console for purposes such as selecting which of the actionable products will be marketed on a palette on a web page of a content site.

The MOE Main Component 1510 is responsible for obtaining and validating user authentication, implementing a message board, and displaying the menu items available to the buyers and merchandisers. The message board allows any validated user to post a new messages or update/delete an existing message.

A Buyer Web Service Component 1511 implements features of the Buyer Console 1032 such as 1) enrolling and profiling on-line merchant sites, and 2) selecting, profiling, and removing actionable products from on-line merchant sites. After being authorized by the MOE main component 1510, a Buyer interacts directly with the Buyer Web Service Component 1511 using the Buyer Console. A detailed description of features available in one embodiment of the Buyer Console is set forth below. In one embodiment all features are exposed as Simple Object Access Protocol (SOAP) compliant Web Services for use by properly authenticated third party processes.

A Merchandiser Web Service Component 1512 implements the features of the Merchandiser Console 1034 such as 1) enrolling and profiling content sites, 2) enabling the Merchandiser to create a pallet form including color, size, shape and layout for a content site page, 3) enabling the Merchandiser to create a site specific or page specific palette consisting of one or more products, and 4) alerting the Merchandiser when a new content page comes on-line and needs to be merchandised. For these purposes, the component 1512 publishes a grouped database 1100(FIG. 11) that includes information regarding palette configuration 114, content site configuration 115, product lists 113, and event-specific product lists 116. A detailed description of features available in one embodiment of the Merchandiser Console is set forth below. In one embodiment all features are exposed as SOAP compliant Web Services for use by properly authenticated third party processes. As customized product lists and event specific product lists are generated by this component 1512, key attributes of those product lists may be extracted into a set of XML files for use by the Palette Serving Engine 1010.

A Data Access Component 1513 manages all database interactions with the Buyer and Merchandiser web service components 1511 and 1512. Particularly, the Data Access Component 1513 manages all interactions with the databases 111, 118, 117, 112, 115, 113, 116, and 114 in the merchandising site, abstracting the other components from the actual database implementation. This component 1513 returns consistently structured datasets in response to requests for data from the other MOE components.

9A. Buyer Console 1032

The Buyer Console is an interface that allows Buyers to efficiently select products from an on-line merchant's online storefront and make them available for our Merchandisers through our system. Features in one embodiment of a Buyer Console allow Buyers to 1) enroll and profile an on-line merchant, 2) capture product images, prices and descriptions directly from the on-line merchant's web site and place them into the actionable products database in the merchandising site (Pick-n-Click), 3) profile the product and define it for key word search or other queries, and 4) maintain the actionable products database by inactivating a product or terminating an on-line merchant. Selected features or tools available in one embodiment of the Buyer Console are set forth below.

### Buyer Quick Stats

The Business Integration Engine 1020 regularly runs a Product Synchronization process discussed with reference to FIG. 13. One purpose of this process is to ensure that product information in the database matches product information on the on-line merchant's web site. Part of the buyer's daily routine is to examine these inactivated products and determine whether the product is no longer available and should be terminated, or the page has changed and the XSL script used by Product Synchronization needs to be modified.

A Buyer Quick Stats“menu can display statistics including the number of products inactivated by buyers and the number of products inactivated by Product Synchronization. Each statistic on this page is a link to detailed information about the statistic.

An “Inactive Products” page lists all of the inactive products ordered by the date they were inactivated, with the most recent listed first. Clicking on a “Modify” link takes the buyer to the “Profile Product” page, which opens a new window on monitor 2 that shows the on-line merchant's page for that product. The buyer can then compare the product information in MOE with the product information on the on-line merchant's page and take appropriate action, such as deleting the product information from the actionable products, or simply updating the information for consistency.

### Creating a Product Record

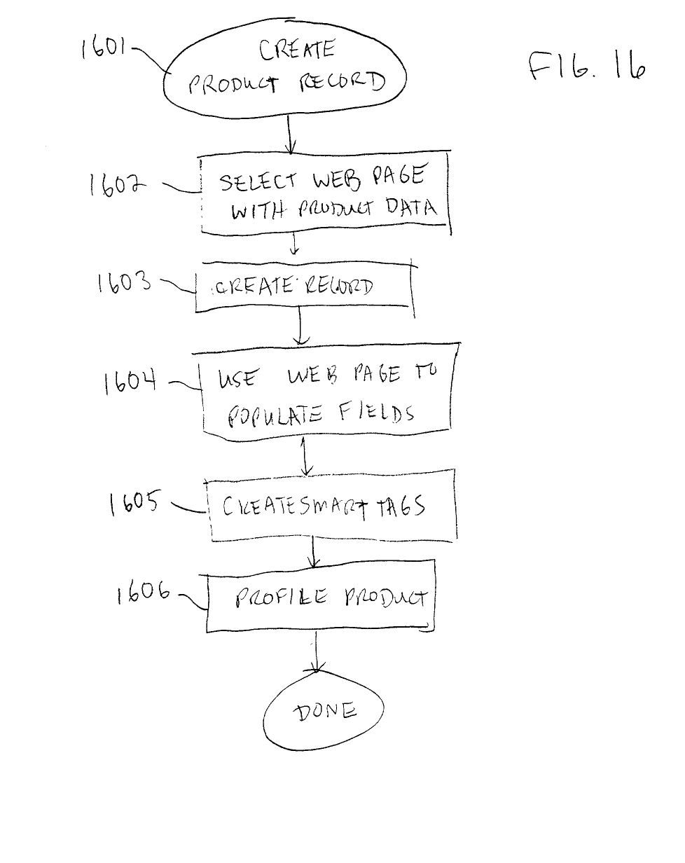

FIG. 16 is a flow chart of steps to create a product record. In one example, this process is implanted as “Pick 'N Click”, discussed below.

At 1601, operation begins to create a product record in the actionable products database 118 (FIG. 1A). At 1602, the Buyer selects the web page with the desired product data, thereby loading it into the Buyer's computer. At 1603, a new record is created in the actionable products database 118 (FIG. 1A). At 1604, information on the web page (e.g. HTML code) is used to populate the fields of the new record, such as price, description(s), visual image, and so forth. At 1605, smart tags are created for the product and associated web page, as discussed elsewhere herein. At 1606, the product information is displayed to the Buyer, and the product may be profiled by the Buyer; for example, the product may be profiled into categories such as a content site type (e.g. auto, baby-boomer, careers, catalogs), a brand image (e.g. discount/value, hi-end, moderate, sporty), a gender appealed to (e.g. female, male, mostly male, split), age groups, and income categories. The profile may be used in searches by Merchandisers, for example. In addition at 1606, the Buyer may review and correct the information automatically entered at 1604.

### Pick 'N Click

Selecting products to save into the actionable products database is simplified by a process, termed “Pick 'N Click.” This process allows the buyer to browse any on-line merchant's web site and save products with a few clicks of the mouse. Selecting the “Pick and Click” link from the Main Menu will open a new browser window, in which the buyer can browser on-line merchant web sites. When a desired product is found, the buyer right-clicks on the picture of the product and selects the “Pick 'N Click” context menu item.

Once the buyer selects the “Pick 'N Click,” a product profile page is presented to the buyer with the product image information and product page URL pre-populated. The buyer then profiles the product by filling out the rest of the information and then saves the product information to the database. The profiles include categories such as a content site category (e.g. auto, baby-boomer, careers, catalogs), a brand image (e.g. discount/value, hi-end, moderate, sporty), seasonal (e.g. Thanksgiving, Mother's Day ),a gender appealed to (e.g. female, male, mostly male, split), age groups, and income categories.

In one embodiment the Merchandising site uses “Smart Tags” to identify products available from on-line merchant sites (tagging). This feature retrieves the Document Object Model of the on-line merchant product page from the browser and saves the product information in the Merchandising site database. While any information available in the Document Object Model is available, the application currently retrieves only the product page URL and product image URL. The product image is copied to the Merchandising site and the Buyer is then able to profile the product. This profile information includes that information to be “collected” and “synchronized” in the future - ex: price and description. This profile information is associated with the information retrieved from the Document Object Model.

### Product Maintenance

Periodically, it may become necessary for the buyer to edit product information. Examples include modifying product descriptions to increase sales, modifying product profile information to assist merchandisers, and terminating old products

The buyer can search for products via a “Product Maintenance” page. Product search criteria may include on-line merchant, keywords, categories, profiles, and brands. After executing the search, the buyer can click on a product in the search results list and be presented with a new window that contains the Product Profile page and the on-line merchant's product web page in monitor 2. The buyer can then edit product information directly on the Product Profile.

### On-line merchant Profile

Buyers can associate on-line merchants with categories on the on-line merchant Profile page. These categories assist merchandisers when choosing products for content pages. Once an on-line merchant is selected, the on-line merchant's web page is loaded, and the buyer can add or remove categories and profiles.

### On-line merchant Maintenance

The buyer uses an “On-line merchant Maintenance” page to add new on-line merchants to the system and edit information about existing on-line merchants. When a buyer selects an on-line merchant, all of the fields on the form are populated according to the select on-line merchant, and the on-line merchant's web page is loaded. The buyer can then change values in the fields.

To add a new on-line merchant, the buyer selects ‘New on-line merchant . . .’ from the ‘on-line merchant Name’ drop-down list. The buyer then enters the name of the new on-line merchant and profiles the merchant according to predefined categories such as image (e.g. discount/value, hi-end, moderate and sporty), gender appealed to (e.g. female, male, mostly male, mostly female, and split), age appealed to (e.g. 0-11, 12-18), and income appealed to (e.g. 0-$34,000, $35,000-$54,000).

A list of affiliate programs may be made available so that the buyer can associate an on-line merchant with one of these by clicking on the affiliate name. When an affiliate is selected, two text boxes appear under the list box to allow the buyer to enter an identifier and URL specific to that on-line merchant-affiliate relationship.

The buyer can enter contact information for an on-line merchant such as sales, technical, merchandising, and accounting personal for an on-line merchant.

### Buyer Assignments

A Buyer Assignments page allows one with sufficient authority to assign on-line merchants to buyers. These assignments may be used elsewhere in MOE to filter content for specific users.

9B. Merchandising Console 1034

The Merchandising Console 1034 in one embodiment enables a Merchandiser to enroll and profile a content site, and to create a palette form for a content site including color, size, shape, and layout. The Merchandising Console can also alert a Merchandiser when a new content page needs to be custom merchandised.

The Merchandising Console may enable a Merchandiser to create a Site Specific Palette. For example a Site Specific Palette may be shown when a content site initially enrolls with the merchandising site. The Site Specific Palette is the default Palette that the system serves before optimizing it with custom merchandising by a human merchandiser, for example. The Merchandiser may create a product assortment of 4 to 9 appropriate products for the site, which will be displayed by the palette. The merchandiser may execute a product search using key word inserted by a Buyer during the product profiling process.

In addition to Site Specific Palettes, the Merchandiser may also create Page Specific Palettes for custom merchandising directed to the context of a page (or a groups of pages) on the content site. The Merchandising Console may notify the Merchandiser if a new content page has been put into the queue for merchandising. In addition, for each page (or a group of pages), the Merchandiser may create a product assortment directed to the context of that page; for example the Merchandiser may conduct a product search and select four to ten key products that match the page content and are appropriate for the audience demographics and psychographics. As discussed elsewhere, a page index may be utilized for this purpose.

Selected features of the Merchandising Console in one embodiment are set forth below.

### Merchandiser Quick Stats

In order to assist the Merchandiser in selecting which pages to merchandise, the “Merchandiser Quick Stats” page and a “Content Pages” page may be used. Content pages are organized on Merchandiser Quick Stats according to page status and dwell time. A page can have the following statuses on the Quick Stats page:

New: No merchandising action has been taken. The site-specific palette is being served for this page.

Optimized: A page-specific palette has been merchandised and is being served for this page.

Awaiting Review: The decision to merchandise this page has been deferred. The site-specific palette is being served for this page.

Declined: Merchandising has decided to not merchandise this page. The site-specific palette is being served for this page.

Terminated: the page may be removed from the database

Another statistic used when prioritizing pages to be merchandised is “Dwell Time”, which is the amount of time the page was up on the client's browser. It may be desirable for pages with a large dwell time to have larger palettes (more products), whereas pages with a short dwell time should have smaller or static palettes.

The list of pages on the “Content Pages” page is determined by which link on the “Merchandiser Quick Stats” page was selected. There are several characteristics about this list of pages that help the merchandiser choose which pages to merchandise: 1) The list is ordered ascending alphabetically by content site, then by Imps (impressions) in descending numeric order. This emphasizes pages with the most revenue potential so that they will be merchandised first. 2) Pages displayed in red have fallen below the minimum click-through rate for that site. 3) Pages displayed in yellow have fallen below the historical click-through rate for that content page.

This information may be useful in assisting the merchandiser in the decision of whether or not to merchandise a page.

### Content Page Merchandiser

The “Content Page Merchandiser” page allows a merchandiser to simultaneously view the content page, the assigned palette form (if created), and the product list (if created). The palette may appear on the page as it would be viewed by a user. While viewing this information, the Merchandiser can create or modify the product assortment and create or modify the palette form.

### Creating a Product Assortment

In order to create a product assortment (i.e. a product list), a merchandiser may perform a search of actionable products using the predefined criteria specified in the product profiles by the buyer. After the merchandiser selects a search criteria and performs a search, search results are presented in the right half of the “Content Page Merchandiser” page. Once the merchandiser finds a desired product, he/she selects it, and then clicks the “Add to Palette” button, and it is added to the product assortment.

### Selecting a Palette Form

The merchandiser can select a palette form after saving a product assortment by clicking on a “Select Palette Form” link, which present a dropdown list to select a list of “Generic Palette Forms” (sorted by form width), or “Specific Palette Forms”, which are

forms created for specific sites or pages (sorted by site/page). The palette form defines the size, color, etc. of a palette. Unlike specific palette forms, generic palette forms have not been created for specific sites and pages. Once a form is selected (by clicking on it once), the form can be saved to the palette.

### Adding Content Pages

The Reporting Engine 1040 adds new content pages (for existing content sites) to MOE automatically. However, on occasion, the merchandiser may find it necessary to add a new content page manually. For example, when a new content site is created, the merchandiser must create a “site default” page that will have the “site-specific” palette. This can be done at the “Content Page Merchandiser” page after selecting a content site. The merchandiser can then specify a page index and page URL and save the new page. If the page is to be the “site default” page, the page index is the size of the palette (‘125_{—}225’ for the 125 pixel by 225 pixel palette size, for example) and the page URL is the site URL. Once the site default page has been saved, the site-specific palette can be merchandised.

### Content Site Profile

Merchandisers can associate content sites with predefined categories on the Content Site Profile page. These predefined categories assist merchandisers when choosing products for content pages. The profiles include categories such as a content site category (e.g. auto, baby-boomer, careers, catalogs), a brand image (e.g. discount/value, hi-end, moderate, sporty), a gender appealed to (e.g. female, male, mostly male, split), age groups, and income categories. Once a content site is selected by a merchandiser, the content site web page is loaded, and the merchandiser can add or remove categories and profiles.

### Content Site Maintenance

The merchandiser can use a “Content Site Maintenance” page to add new content sites to the system or edit information about existing content sites. When a merchandiser selects a content site from the ‘Content Site Name’ drop-down list, all of the fields on the form are populated according to the selected content site, and the content site web page is loaded. The merchandiser can then change values in the fields.

To add a new content site, the merchandiser selects ‘New Content Site . . .’ and the merchandiser is presented with a text box in which to enter the name of the new content site. The merchandiser can then save the new content site and proceed to enter other information, or cancel the new addition.

A list of affiliate programs is provided so that the merchandiser can associate a content site with one or more of these affiliate names. For each affiliate that is selected, four text boxes appear under the list box (middle column of FIG. 28) to allow the merchandiser to enter an identifier, URL, username, and password specific to that content site-affiliate relationship.

The merchandiser can enter contact information for a content site in a ‘Contact Info’ page, allowing the merchandiser to enter contact information for sales, technical, merchandising, and accounting personal for a content site.

### Merchandiser Assignments

A Merchandiser Assignments page allows a user with sufficient authority user to assign content sites and categories to merchandisers. These assignments are used elsewhere in MOE to filter content for specific users.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

What is claimed is:

1. A networked system including a merchandising site for merchandising a plurality of products to a plurality of users who access said network via a browser that views pages served by a plurality of content sites, said plurality of products available from a plurality of on-line merchants, the system comprising:
means for selecting at least one product associated with a predetermined page served by one of the content sites;
means for inserting a palette in a reserved area of said predetermined page, said palette including said selected product;
means, responsive said user selecting said product on said palette, for connecting said user to a web site of a predetermined on-line merchant;
means for receiving a commission from said merchant site payable to said merchandising site; and
means for paying a portion of said commission to said content site.

2. The system of claim 1 wherein said commission comprises a referral fee.

3. The system of claim 1 wherein said commission comprises a sales commission.

4. A method for merchandising one or more products by a merchandising site to a user of a browser viewing a predetermined page from a content site on a computer connected to an on-line electronic network, said method comprising:
in a merchandising site, receiving a request from said browser for a palette;
selecting a palette responsive to said request and said predetermined page, said palette including a product selected by said merchandising site;
transmitting said selected palette from said merchandising site, and transmitting therewith product information for said palette, said product information including purchasing information for said product from an on-line merchant;
receiving a commission from said merchant payable to said merchandising site; and
paying a portion of said commission from said merchandising site to said content site.

5. The method of claim 4 wherein said commission received by said merchandising site comprises a referral fee.

6. The method of claim 4 wherein said commission received by said merchandising site comprises a sales commission.

7. The method of claim 4 wherein said purchasing information includes at least one of price, description, and visual image of said product.

8. A method for merchandising one or more products by a merchandising site to a user of a browser on a computer connected to an on-line electronic network, comprising:
in a merchandising site, receiving a request for a palette from said browser;
responsive to said request, detecting a configuration of said computer of said user;
responsive to said computer configuration, selecting a palette that includes a product selected by said merchandising site;
transmitting said selected palette from said merchandising site, and transmitting therewith product information for said palette, said product information including purchasing information for said product from an on-line merchant.

9. The method of claim 8 wherein said commission received by said merchandising site comprises a referral fee.

10. The method of claim 8 wherein said commission received by said merchandising site comprises a sales commission.

11. The method of claim 8 wherein said purchasing information includes at least one of price, description, short statement, and visual image of said product.

12. The method of claim 8 wherein said selecting step includes selecting a static palette including only one product if a first configuration is detected, and selecting a dynamic palette including a plurality of products if a second configuration is detected.

13. The method of claim 8 wherein said detecting step includes detecting whether said computer has predefined software installed and enabled.

14. The method of claim 13 wherein said predefined software comprises at least one of Java Virtual Machine, Flash, Microsoft Common Language Runtime, and DHTML.

15. The method of claim 13 wherein said selecting step includes selecting a dynamic palette including a plurality of products if predefined software is installed and enabled, otherwise selecting a static palette including only one product.

16. The method of claim 15 wherein said predefined software comprises at least one of Java Virtual Machine, Flash, Microsoft Common Language Runtime, and DHTML.

17. A method for merchandising one or more products to a user of a browser viewing a predetermined page served by a content site connected to an on-line electronic network, comprising:
receiving a request for a palette from said browser to a merchandising site;
selecting a palette responsive to said request, said palette including a product selected by said merchandising site;
transmitting said selected palette from said merchandising site, and transmitting therewith product information for said palette, said product information including purchasing information for said product;
responsive to selection by said user of said product in said browser, connecting said user with a merchant for said product;
receiving a commission from said merchant payable to said merchandising site; and
paying a portion of said commission from said merchandising site to said content site.

18. The method of claim 17 wherein said commission received by said merchandising site comprises a referral fee payable when said user is connected to said merchant.

19. The method of claim 17 wherein said commission received by said merchandising site comprises a sales commission payable when said product is purchased by said user.

20. The method of claim 17 wherein said purchasing information includes at least one of price, description, short statement, and visual image of said product.

21. A method for contextually merchandising one or more products to a user of a browser on a computer connected to an on-line electronic network that includes a merchandising site, comprising:
responsive to the context of a web page of a content site, pre-selecting at least one product to associate with said web page by said merchandising site;
receiving a request in said merchandising site for a palette from said browser, said request generated responsive to opening said web page by said user;
selecting a palette by said merchandising site responsive to said request, said palette including at least one of said pre-selected products;
transmitting said selected palette from said merchandising site for display on said user browser, including transmitting therewith product information for said palette, said product information including purchasing information for said product;
responsive to selection by said user of said product in said browser, connecting said user with a merchant for said product;
receiving a commission from said merchant; and
paying a portion of said commission to said content site.

22. The method of claim 21 wherein said commission received by said merchandising site comprises a referral fee payable when said user is connected to said merchant.

23. The method of claim 21 wherein said commission received by said merchandising site comprises a sales commission payable when said product is purchased by said user.

24. The method of claim 21 wherein said purchasing information includes at least one of price, description, short statement, and visual image of said product.

25. The method of claim 21 further comprising inserting said palette into a predetermined area in said web page on said user browser.

26. The method of claim 21 further comprising displaying said palette in the format of a pop-up window on said user browser.

27. A method of doing business from a merchandising site using an on-line electronic network that includes a plurality of content sites associated with said merchandising site, each associated content site serving a plurality of web pages, said method comprising:
receiving a plurality of affiliate tags from at least two of an on-line merchant, a third-party affiliate program, and a referring URL that refers to said merchandising site, said affiliate tags indicating a commission payable to said merchandising site;
allocating said affiliate tags by said merchandising site to uniquely associate an affiliate tag with each of said associated content sites;
supplying a palette from said merchandising site for insertion into a web page served to a user browser by a content site selected by the user of said user browser, said palette displaying at least one product to the user;
connecting said user browser with said merchant site, including associating said user browser with an affiliate tag allocated to said selected content site;
receiving a commission from said merchant site, said commission payable to said merchandising site, and said commission associated with said affiliate tag; and
paying a portion of said commission from said merchandising site to said selected content site.

28. The method of claim 27 wherein said commission received by said merchandising site comprises a referral fee payable when said user is connected to said merchant.

29. The method of claim 27 wherein said commission received by said merchandising site comprises a sales commission payable when said product is purchased by said user.

30. The method of claim 27 wherein said purchasing information includes at least one of price, description, short statement, and visual image of said product.

31. A method of synchronizing a product record in an actionable products database at a merchandising site with product data available over an on-line electronic network, said actionable products database including actively marketed products and inactive products, each product having an associated merchant that has an on-line merchant site, said method comprising:
creating a smart tag associated with a selected product in said product merchandising database, including attributes used to identify how to retrieve on-line product data from the merchant associated with the selected product;
using said smart tag to access on-line product data for said selected product from said merchant site;
comparing said on-line product data with the corresponding product record stored in said product merchandising database;
if said on-line product data is equal to said product record, then completing operation;
if said on-line product data is not equal to said product record, then determining if the difference is less than a predetermined threshold;
if said difference is less than a predetermined threshold, then automatically updating the product record for said selected product in said product merchandising database to correspond with said on-line product data; and
otherwise, removing said selected product from actively marketed products, thereby temporarily inactivating said product, and reporting said removal for further review.

32. The method of claim 31 wherein said merchandising site comprises a plurality of customized product lists, and if said difference is otherwise than less than a predetermined threshold, then removing said product from customized product lists.

33. The method of claim 31 wherein said actionable products database comprises a plurality of products for which said smart tags have been previously created, and further comprising periodically repeating said synchronization steps for each of the actionable products in said actionable products database.

34. A method for using an on-line electronic network by a Buyer to create a product record for an actionable products database comprising:
selecting a web page of a content site that includes product data for a selected product;
creating a record for said selected product in said actionable products database;
utilizing said selected web page to populate predetermined fields of said created record;
creating a smart tag for said product that includes attributes used to identify how to retrieve on-line product data from the merchant associated with the selected product; and
profiling said product by said Buyer and storing said profile in said product record.

35. The method of claim 34 wherein said profiling step includes categorizing said product, selecting a price range, selecting a brand name, and selecting a seasonal indicator.

36. The method of claim 34 wherein said step of creating a smart tag includes creating attributes used to identify an on-line merchant associated with said product.

37. A method for indexing a plurality of web pages of content sites connected to an on-line electronic network, comprising:
selecting a first group of web pages from a first content site;
assigning a first index value to said first group indicative of the addresses of said web pages,
creating a first product list for said first group, and associating said first index value with said first product list;
selecting a second group of web pages from a second content site;
assigning a second index value to said second group indicative of the addresses of said web pages;
creating a second product list for said second group, and associating said second index value with said second product list; and
in response to a request received by said merchandising site relating to one of said web pages, determining the index assigned to said web page, thereby associating the product list associated with said web page.

38. A method of merchandising products over an on-line electronic communication network that has a plurality of web sites including a merchandising site, a plurality of content sites each having a plurality of pages, and a plurality of merchant sites each having at least one product available for sale, comprising:
inserting a predefined link into one of said content site pages, said link identifying said merchandising site;
selecting said content site page by a user browser and displaying said content site page on said user browser;
utilizing said predefined link to communicate a request from said user browser to said merchandising site, said request including a request code that includes information indicative of said content site page;
responsive to said request code received by said merchandising site, supplying a palette from said merchandising site to said user browser, said palette including
displaying said palette on said user browser;
selecting said product from said palette by said user browser;
responsive to said selection of a product, connecting said user browser with the merchant site corresponding to the merchant associated with said product, including connection to a web page corresponding to said selected product, supplying an affiliate tag to said merchant, and displaying said web page on said user browser;
purchasing said product, or viewing additional information about said product, from said merchant by said user browser;
providing a commission by said merchant to the merchandising site, including an indication of the account corresponding to said affiliate tag; and
receiving said commission from said merchant by said merchandising site,
and distributing a portion of said commission to the owner of said content site.

39. The method of claim 38 further comprising supplying palette information together with said palette including:
palette style including palette type, size, layout, and colors;
a product list including product detailed information for one or more products; and
a product visual image for each product in the product list.

40. The method of claim 38 wherein when the palette type is dynamic said user browser selects a predefined button on said palette, thereby generating a request to said merchandising site, and responsive thereto sending from said merchandising site to said user browser, information about a second product and a link to at least one merchant having said second product available for sale, and displaying said second product on said palette on said user browser.

41. The method of claim 38 wherein when the palette type is dynamic or multi-product static said palette includes a plurality of products.

42. The method of claim 38 wherein said request code includes an orientation of the palette on said content site page and an owner of said content site page, and further comprising the step of communicating said orientation and said owner together with said request from said user browser to said merchandising site.

43. The method of claim 38 further comprising the step of communicating a cookie together with said request from said user browser to said merchandising site, said cookie including a shopping history for said user browser.

44. The method of claim 38 further comprising supplying, together with said palette, a plurality of merchant sites having said product available for sale.

45. The method of claim 38 further comprising selecting a product that is available from a plurality of on-line merchants, and selecting one of said plurality of merchants by said user browser.

46. The method of claim 38 wherein said step of displaying said merchant web page further comprises displaying a transition page on said user browser indicating said user is being redirected off of said content site page.

47. A method of merchandising products over an on-line electronic communication network from a merchandising site to a plurality of users on behalf of a plurality of merchants, said on-line electronic communication network comprising a plurality of web sites including a plurality of user browsers, a plurality of merchandising sites operated by said plurality of merchants, and a plurality of content sites each having at least one linked page that includes a page-specific predefined link, comprising:
a) receiving a request in the merchandising site from a first one of said user browsers responsive to loading a first one of said linked pages;
b) responsive to said request, supplying a palette from said merchandising site to said first user browser including product information relating to at least one of said merchant sites that has said product available for sale;
c) supplying an affiliate tag from said merchandising site to said on-line merchant for each merchant having said product in said palette available for sale, each of said affiliate tags uniquely identified with said content site;
d) receiving a commission in said merchandising site attributed to said affiliate tag from at least one of said merchants supplied with said palette; and
e) distributing a portion of said commission from said merchandising site to said content site.

48. The method of claim 47 further comprising repeating each of said steps for each of a plurality of said user browsers.

49. The method of claim 47 further comprising supplying, together with said palette, a plurality of merchant sites having said product available for sale.

50. The method of claim 47 wherein when the palette type is dynamic or multi-product static said palette includes a plurality of products.

51. The method of claim 47 further when the palette type is dynamic comprising providing a product list including a plurality of products for said first content page, and said step (b) comprises providing a first product on said product list to said user browser.

52. The method of claim 51 when the palette type is dynamic wherein a second request is received by said merchandising site, responsive thereto sending from said merchandising site to said user browser, information about a second product on said product list, and displaying said second product on said palette on said user browser.

53. The method of claim 52 further comprising performing said steps (c), (d) and (e) for said second product.

54. The method of claim 47 wherein said request includes an orientation of the palette on said linked page, and also includes an owner of said content site, and further comprising the step of communicating said orientation and said owner together with said request from said user browser to said merchandising site.

55. The method of claim 47 further comprising receiving in said merchandising site a cookie together with said request, said cookie including a shopping history for said user browser.

56. The method of claim 47 further comprising sending a transition page from said merchandising site to said user browser indicating said user is being redirected off of content site page.

57. A merchandising site connected to an on-line electronic communications network that has a plurality of web sites including a plurality of content sites each having a plurality of web pages and a plurality of merchant sites, and a plurality of user browsers that can request information from said merchandising, content, and merchant sites, comprising:
a web server connected to said electronic communication network;
a plurality of databases including
an actionable products database that includes selected products from said plurality of associated merchant sites, each product associated with one or more of said associated merchants,
a customized product list database including a plurality of customized product lists, with said customized product lists linked to said actionable products database,
a event-specific product lists database that includes a plurality of product lists associated with predetermined events, said product lists linked to said actionable products database,
an affiliate tags database for each merchant that includes an affiliate tag for each content site, said affiliate tag providing a commission payable to said merchandising site for commissions associated with said affiliate tag;
a product performance database that includes statistics on the performance of each product in the actionable database;
an on-line merchants database that includes all merchants with products in the actionable database;
a content site database that includes all content sites hosting palettes,
a palette configuration database,
a plurality of computer programs coupled to said databases and said electronic communications network, including
a Merchandising Optimization Engine comprising a buyer console and a merchandiser console, the buyer console for merchandising site to select products from said plurality of associated merchant sites, each product associated with one or more of said associated merchants, the merchandising console also for generating said customized product lists;
a Palette Serving Engine for supplying requested palettes from said merchandising site to said user browser, providing connection from said user browser to a web page corresponding to selected product with the appropriate affiliate tag identifying said content site, and update the product performance database for all products in said customized product list;
a Business Integration Engine providing on-line merchant product synchronization for updating the actionable database on a scheduled bases and also providing affiliate program synchronization for updating product performance database with collected commissions to said content sites reported by third-party affiliate programs; and
a Reporting Engine that quantifies overall Merchandising And Affiliate System performance including said individual product performance, said on-line merchant performance, said content site page performance, said content site performance, said palette performance, commissions collected from said on-line merchant sites, commissions due said content sites, and commissions due said merchandising site.

58. The site of claim 57 wherein said product lists are customized for a particular content site.

59. The site of claim 57 wherein said product lists are customized for a particular content site page.

60. The site of claim 57 wherein said on-line merchants database includes merchant profiles, merchant performance, and merchant affiliate information.

61. The site of claim 57 wherein said content site database includes content site profiles, content site performance, and content site affiliate information.

62. The site of claim 57 wherein and each product associated with a smart tag used to identify how to retrieve said product information from said on-line merchant site and update actionable database.

63. The site of claim 62 wherein the merchandiser console comprises a system for associating smart tags with each product.

64. The site of claim 62 wherein said Business Integration Engine utilizes said smart tags to synchronize product information.

65. A method of providing a commission to a content site from sales of products by a plurality of merchant sites over an on-line electronic communications network that includes said content site, said merchant sites, a merchandising site, and a plurality of user browsers, comprising:
reserving an area in a page of said content site;
embedding a link into said page, said link including a link to said merchandising site to request a palette, so that when said page is loaded into one of said user browsers, said link generates a request from said merchandising site, said palette including at least one product available for sale, said palette occupying said reserved area; and
responsive to a sale of said product on said palette by one of said associated merchant sites, receiving a commission from said merchandising site for a portion of the commission received from the merchant site by said merchandising site.

66. The method of claim 65 wherein said step of embedding said link includes embedding information indicative of the orientation of the palette on said content site page and the owner of said content site.

67. A method of selling products from a merchant site over an on-line electronic communication network that has a plurality of user browsers and plurality of web sites including a merchandising site having a plurality of products available for sale and a plurality of content sites having a plurality of pages, comprising:
providing, from said merchant site to said merchandising site, a plurality of product descriptions and web links associated with purchasing said products;
assigning a plurality of affiliate tags to said merchandising site when said on-line merchant site is a member of a third-party affiliate program;
assigning a plurality of affiliate tags by said merchandising site when said on-line merchant site is not a member of a third-party affiliate program;
selling a product from said merchant site to a first user using one of said user browsers in a transaction in which one of said affiliate tags is associated with said sale to generate a first commission;
selling a second product from said merchant site to a second user using one of said user browsers in a second transaction in which a different one of said affiliate tags is associated with said second sale to generate a second commission; and
paying said first and second commissions to said merchandising site.
